(19) United States
(12) Patent Application Publication
(10) Pub. No.: US 2014/0310046 A1
(43) Pub. Date: Oct. 16, 2014

(54) SYSTEM AND METHOD FOR ON-LINE EVENT PROMOTION AND GROUP PLANNING

(71) Applicant: Rundavoo, Inc., Los Angeles, CA (US)

(72) Inventor: Farid Shidfar, Los Angeles, CA (US)

(21) Appl. No.: 14/314,736

(22) Filed: Jun. 25, 2014

Related U.S. Application Data
(63) Continuation-in-part of application No. 13/965,694, filed on Aug. 13, 2013.
(60) Provisional application No. 61/838,963, filed on Jun. 25, 2013.
(60) Provisional application No. 61/682,510, filed on Aug. 13, 2012.
(60) Provisional application No. 61/765,295, filed on Feb. 15, 2013.

(51) Int. Cl. G06Q 10/10

(52) U.S. Cl. CPC G06Q 10/1095
USPC 705/7.19

(57) ABSTRACT

Systems and methods are provided for enabling event planning and promotion using on-line collaboration tools among a group of people, wherein the group arrives at a decision, such as a decision as to the nature and/or logistics corresponding to an event in which the group wishes to participate, and wherein the collaboration tools include the ability to provide links to perform transactions related to the defined event.

### CROSS-REFERENCE TO RELATED APPLICATIONS

This application claims the benefit of the following provisional application: U.S. patent application Ser. No. 61/838,963, filed Jun. 25, 2013.

This application is a continuation in part of and claims the benefit of the following non-provisional application: U.S. patent application Ser. No. 13/965,694, filed Aug. 13, 2013, which claims the benefit of U.S. patent application Ser. No. 61/682,510, filed Aug. 13, 2012 and U.S. patent application Ser. No. 61/765,295; filed Feb. 15, 2013.

Each of these applications is incorporated herein by reference in its entirety.

### FIELD

This disclosure relates to a system and method for event promotion and group activity planning through the use of public/private events and private gathering web pages, enabling on-line collaboration amongst potential event participants, and allowing transactions related to an event to be made.

### BACKGROUND

It is typical for participants in social events to find out about a social gathering or event coordinated by, for example, friends, family and/or coworkers via email, Evite, Facebook, SMS or a phone call. Thereafter, planning headaches often begin as the organizer tries to collaborate with everyone to obtain consensus regarding the group plans and decisions, logistics, and sharing of expenses.

Furthermore, formal studies indicate that the most compelling communication combines both visual and non-visual content. For example, people remember approximately 80% of what they see and do, 20% of what they read and only 10% of what they hear. Even so, non-visual content sites and modalities, such as email, Evite, Facebook, SMS and the like are widely used to plan and organize social gatherings and events.

There is therefore a need for a highly collaborative and visually engaging event and social planning platform to coordinate events and social gatherings in an easy and effective manner.

### SUMMARY

This disclosure relates to methods and systems for event planning, wherein the methods and systems include defining an information object including an event and a plurality of event attributes for a proposed event of a defined group of people, the information object including at least one multimedia presentation of at least one attribute of the event. The information object is sent to at least one member of the group. At least one vote as to the value of at least one of the plurality of event attributes is solicited and received from at least one member of the group. The votes are used to select a value for at least one event attribute for the proposed event; and the event information object is transformed to present a modified event based on the voting.

The disclosure also relates to methods and systems for event planning including adding a gathering creation link to a public event web page for creating a private web page; receiving information via the gathering creation link to define a proposed gathering related to the event; and creating, with the received information, a private web page accessible to a defined group of potential participants of the proposed gathering, wherein the private web page includes a link for performing a transaction related to the event.

### BRIEF DESCRIPTION OF FIGURES

FIG. 1 is a flow diagram for event planning according to an exemplary and non-limiting embodiment;

FIG. 2 is an illustration of a suggestion home page web page according to an exemplary and non-limiting embodiment;

FIG. 3 is an illustration of an interactive plan web page according to an exemplary and non-limiting embodiment;

FIG. 3a is an illustration of an interactive plan web page according to an exemplary and non-limiting embodiment;

FIG. 4 is an illustration of a login authenticate page according to an exemplary and non-limiting embodiment;

FIG. 5 is an illustration of a share with friends web page according to an exemplary and non-limiting embodiment;

FIG. 6 is an illustration of an ask question web page according to an exemplary and non-limiting embodiment;

FIG. 7 is an illustration of a suggestion web page according to an exemplary and non-limiting embodiment;

FIG. 8 is a flow diagram for an invitee of an event according to an exemplary and non-limiting embodiment;

FIG. 9 is a block diagram of a system for promoting events by accessing and populating a plan web page template according to an exemplary and non-limiting embodiment;

FIG. 10 is an illustration of a public plan template/link generation web page according to an exemplary and non-limiting embodiment;

FIG. 11 is an illustration of a generated plan web page according to an exemplary and non-limiting embodiment;

FIGS. 12-16 illustrate a mobile application for event planning according to an exemplary and non-limiting embodiment;

FIGS. 17-22 are examples of web pages that are involved in an exemplary process for event promotion and group planning;

FIG. 23 is a schematic illustration of the integration of an event planning tool with various other websites/tools;

FIGS. 24-41 illustrate a mobile application for the iPhone for event planning according to an exemplary and non-limiting embodiment;

FIG. 42 is an illustration of the process of event planning and generation of public and private plan web pages;

FIGS. 43-45 are examples of web pages that are used to generate public or private plan web pages; and

FIG. 46 is an example of analytic and reporting data related to the Link/Widget button.

### DETAILED DESCRIPTION

One aspect of this disclosure relates to a system and method for enabling on-line collaboration among a group of people, such as a group of friends, an affinity group, a fan club, a group of co-workers, a team, or the like, to arrive at a decision, such as a decision as to the nature of an event in which the group wishes to participate. As described more fully below in accordance with exemplary and non-limiting embodiments, a web-based platform allows users to interact with one another via the visual elements of a web page to engage in numerous facets of planning around a group decision, such as a decision related to an event, a social gathering, or the like.

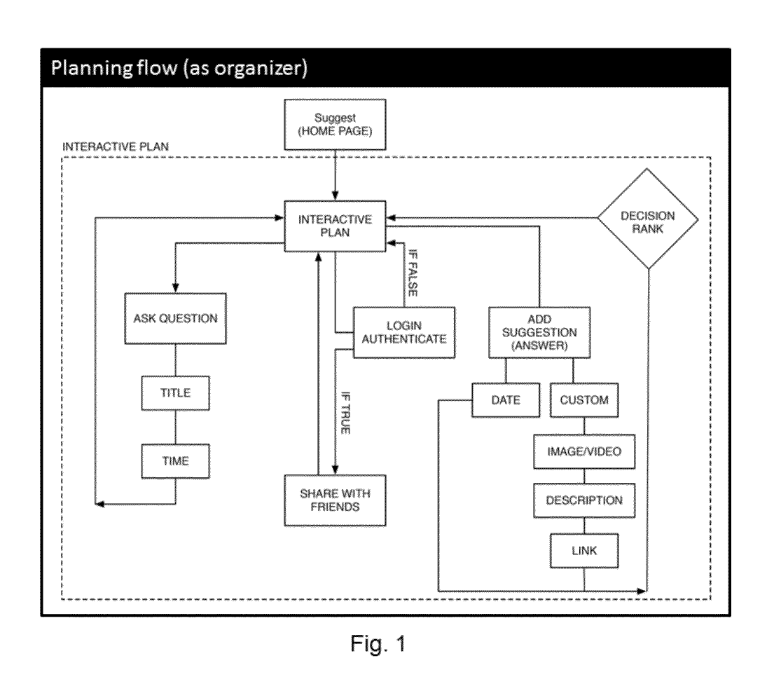

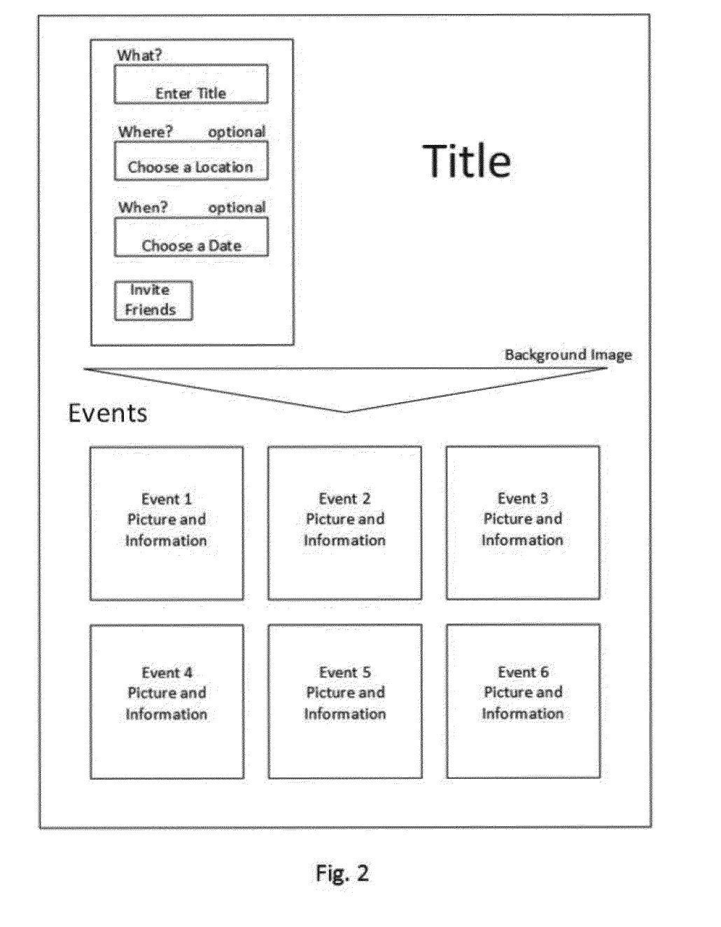

With reference to FIG. 1, illustrated is a flow diagram of an interactive event planning process showing various activities enabled by the system according to exemplary and non-limiting embodiments. Access to the system may be enabled by entering data into a web-based suggestion home page. With reference to FIG. 2, illustrated is a suggestion home page for suggesting a social gathering or event according to exemplary and non-limiting embodiments. As illustrated, suggestion home page comprises a text input box that allows for an alphanumeric input and a submission button. Data entered into the text input box becomes the title of a social gathering/event.

In accordance with exemplary embodiments, a background of the web pages displayed to a user may be customizable. In other embodiments, users may be provided access to a tutorial explaining the features of the system and providing examples.

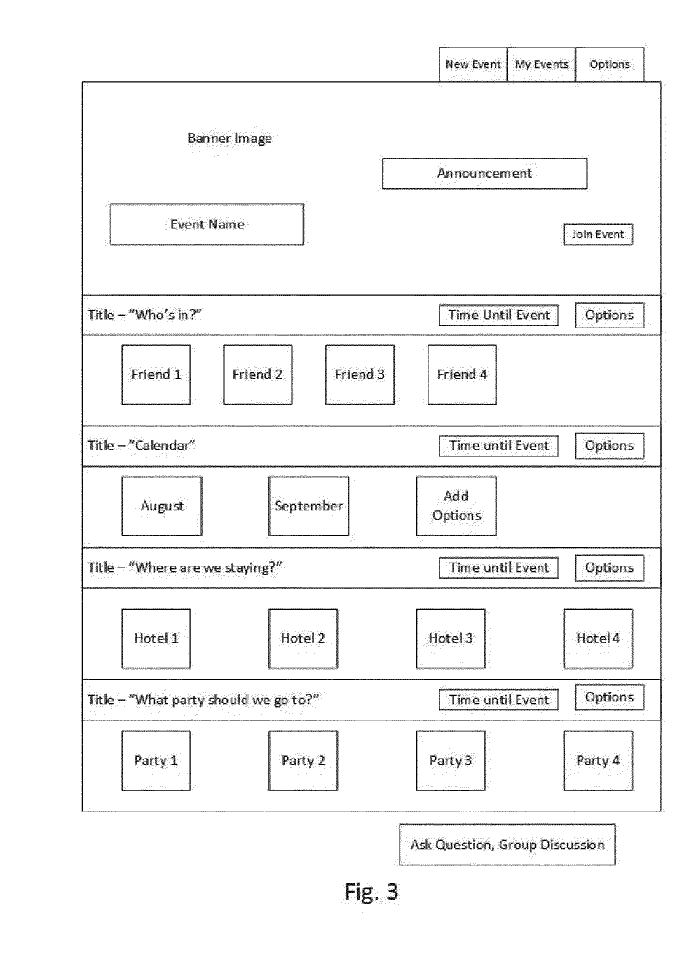

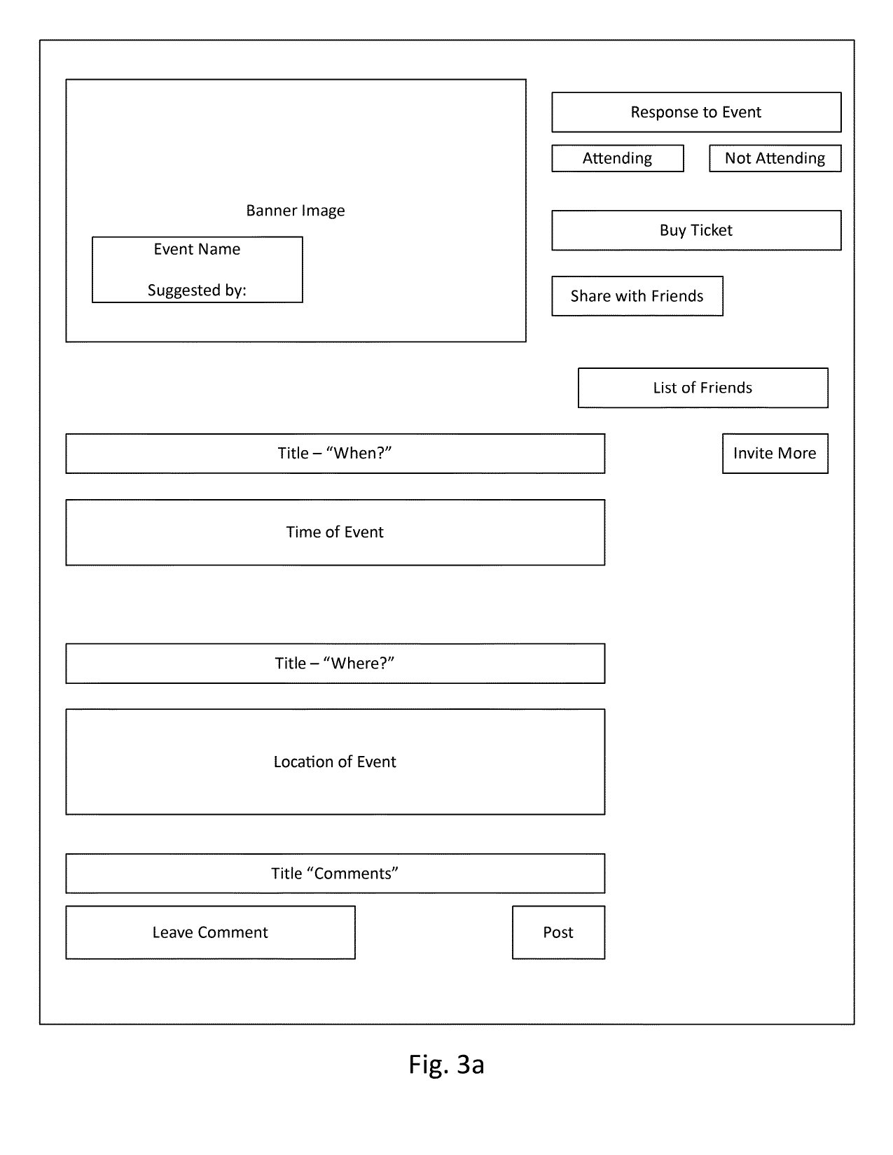

With continued reference to FIG. 1, after submitting the data entered into the suggestion home page, a user is directed to the interactive plan page. With reference to FIG. 3 and FIG. 3a, there are illustrated interactive plan pages according to exemplary and non-limiting embodiments. An interactive plan page functions as a canvas whereupon interactions amongst authenticated users take place for a social gathering. The interactive plan page is a visual summary of the entire social gathering which may include, dates, times, locations, questions, timers associated with questions, answers, votes, decisions, who is involved, and the like.

In accordance with other exemplary embodiments, an interactive plan page may have a customizable background as well as a summary of user related or social gathering related events. Events so summarized may include dates, times, locations, questions, answers, votes, vote tallies, decisions (made and pending), and a decision countdown timer associated with each decision showing days, hours, minutes and seconds remaining until the window to make a selection has expired. In accordance with various other embodiments, an interactive plan page may enable users to create new events, view a user's events and access a user's account.

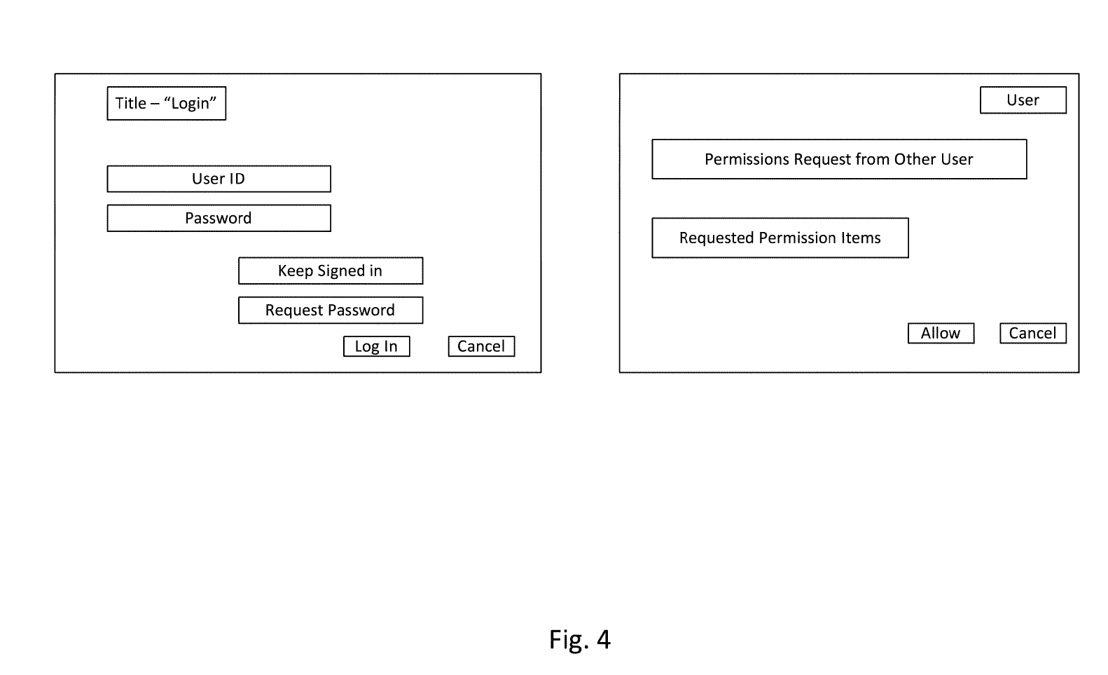

With continued reference to FIG. 1, upon receiving display of the interactive plan page, a user may proceed to, for example, share a social gathering with other users, ask questions, add suggestions and the like. With reference to FIG. 4, there is illustrated a login authenticate page according to exemplary and non-limiting embodiments. The Login authenticate page functions to authenticate a user to the system. In accordance with an exemplary embodiment, authentication may be performed utilizing a third party API. In such an instance when a user connects to the system using a third party API, the user is logged into the system using the third party API Credentials. In accordance with other exemplary embodiments, third party APIs, such as those of Facebook, Twitter, LinkedIn and Google+, may be utilized for authentication purposes.

If it is a user's first time connecting to the system, the system builds a profile for the user and stores the profile in the system. Such profiles may include data such as name, gender, age, location, email address, mobile number, etc.

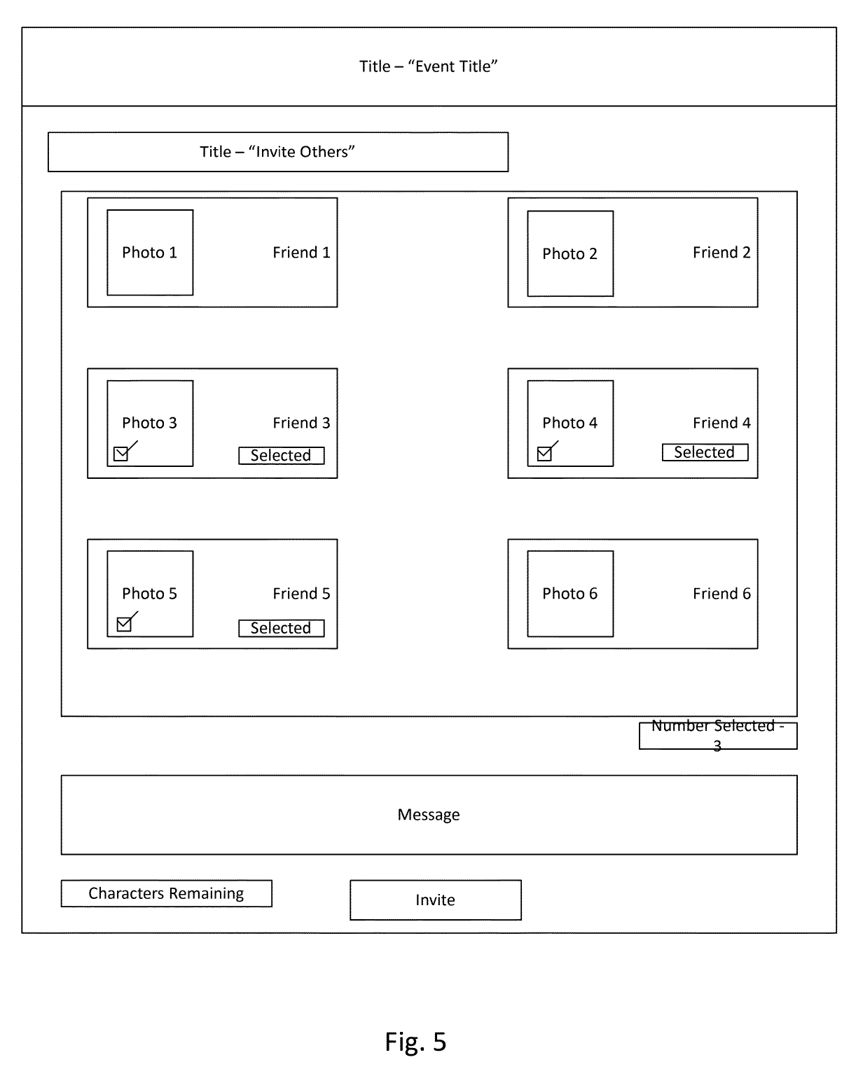

With continued reference to FIG. 1, after being authenticated, a user may proceed to share a social gathering or event with other users. With reference to FIG. 5, there is illustrated a share with friends page according to exemplary and non-limiting embodiments. A Share with friends page allows users operating as social gathering planners to invite their friends to a social gathering. In an exemplary embodiment, the system pulls friends of the user from a Facebook API, displays the friends, and allows a planner to select those friends which they would like to join their social gathering. In one embodiment, planners are enabled to include a private message with their invitation. In an exemplary embodiment, the ability to send a private message is enabled when an email is sent to an existing user of the system. The share with friends page includes an invite button which executes and sends the actual invitation. When a friend is invited by a planner to a social gathering, they are sent, for example, a Facebook App notification. If they are already a user of the system, they may also be sent an email. In accordance with exemplary and non-limiting embodiments, a user having a large number of friends to whom he/she wishes to invite to join in planning and executing a social gathering may do so in an unstructured manner. Specifically, the user may send a link to an invite by email to all of his/her friends without having to select a specific set of people from a pre-defined list, as would be necessary with an invite-specific system.

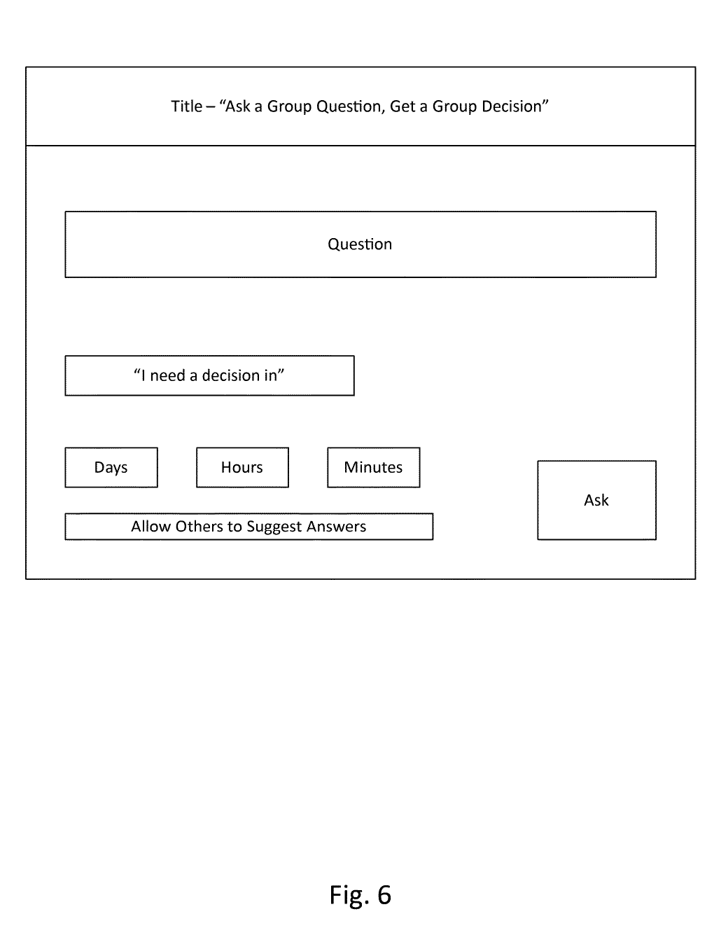

With continued reference to FIG. 1, from the interactive plan page a user may proceed to ask a question of the other users engaged in the social gathering. With reference to FIG. 6, there is illustrated an ask question page according to exemplary and non-limiting embodiments. An Ask question page allows users, each acting as a social gathering planner, to ask questions, suggest answers, and come to a decision around group gatherings. The first step of this process is asking a question. A sample question could be “Which hotel should we stay at?” or “How should we get there?” or “What kind of shoes should we wear?” Every question has a title that is simply an alphanumeric description. Every question also has a timer associated with it which is essentially a time and date for when a decision must be made. Planners can also decide whether or not they want others to be able to suggest answers to their question.

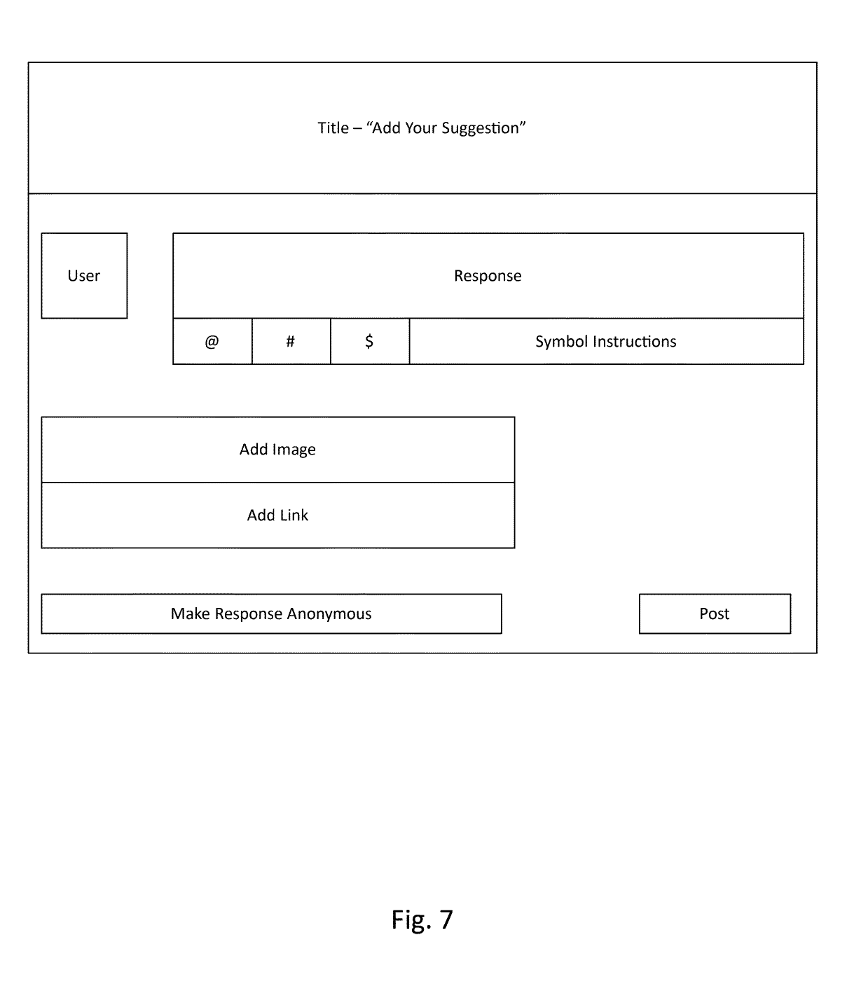

With continued reference to FIG. 1, from the interactive plan page a user may proceed to add a suggestion to or answer a question from one of the other users engaged in the social gathering. With reference to FIG. 7, there is illustrated a suggestion page according to exemplary and non-limiting embodiments. A suggestion is a potential option that answers a proposed question. An example of this might be “Planet Hollywood Hotel and Resort” or “The Cosmopolitan of Las Vegas” to the question of “Where should we stay (in Las Vegas)?” Suggestions can either be a date or a custom answer. Dates are simply a time and actual calendar date. A custom answer may include a description, image/video, a link and the like. An example of a description could be “@Planet Hollywood $200/night for 2 #queen beds” where “@” signifies a place or person, “#” signifies products or things, and $ signifies a price. An image may be a bitmap (jpg, png, gif) and may be, for example, 150 px in width/height. A video can be uploaded/recorded in, for example, mpg format and may be less than perhaps 15 seconds in length. A link may be a hyperlink to a webpage that relates to the suggestion.

With continued reference to FIG. 1, when a suggestion is received from a user, such as via a suggestion page, the suggestion may be assigned a rank. Ranking suggestions helps to reduce the occurrence of no one suggestion receiving majority approval as may occur when there are various options given to a group and the group is asked to make a decision. Decision ranking helps to ensure that a group comes to a decision around a given question by the deadline for that question. Decision ranking takes into account votes for an answer as well as factors specific to the planner voting including, but not limited to, a time at which the planner voted, hierarchy, a number of social gatherings a planner has been involved in, a number of questions a planner has asked, a number of suggestions a planner has made, and a number of purchases a planner has made in the system.

When ranking or weighting the votes of individuals, the system may take into account various attributes of each user/planner. Exemplary attributes include, but are not limited to, a time when the user voted, a number of events the user participated in, a number of questions asked by the user, a number of answer suggestions made by the user, a number of votes cast by the user and a number of purchases made by the user. Other factors may include public vs. private voting, sequential voting, veto/black-ball, utility/% allocation voting, iterative voting, Poison pill—deliberate sabotage, Zero sum (user can't attend if he/she chooses losing option), shared pot (reward for voters who choose winner) and the like.

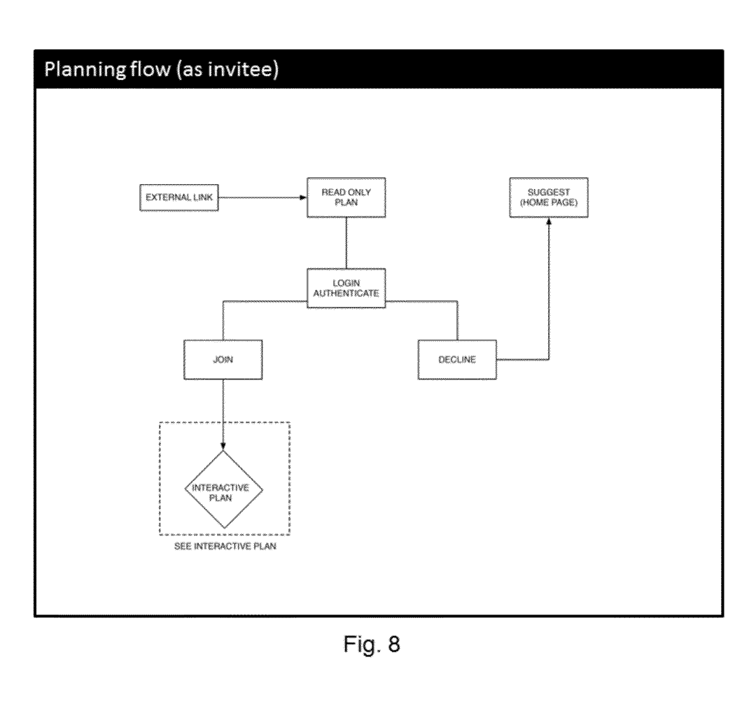

With reference to FIG. 8, there is illustrated a flow diagram for an invitee relating to providing access to a social gathering space enabled by the system according to exemplary and non-limiting embodiments. As illustrated, a user may be directed to a read only plan page from an external link such as a hypertext link on an external website directing the user to a specific social gathering on the system. This Read only plan page may be similar to the interactive plan page but it does not actually allow the viewer to interact with other users until they login and become a participant or planner. As illustrated, once logged in and authenticated, a user may join, such as by activating a “join” button on the read only plan page. Once a user has logged in and clicked “join” they are accepting an invite to a specific social gathering and they then become a participant or planner of that specific social gathering. If, conversely, the user declines the invitation, they are not accepted by the system as a user/planner for the specific social gathering to which they were invited. After selecting to join the social gathering, the user proceeds to the interactive plan page and proceeds as described above.

In addition to the features discussed above, the system enables various other user activities according to exemplary and non-limiting embodiments. For example, users/planners can control which users may invite other users. Users can control which users may suggest questions. Users can control which users may suggest answers. Users can control which users may vote. Users can control user's decision timers for posted questions. Users can delete a user and their respective votes. Users can set a social gathering to be Private in which only the invited users can join. Users can set a social gathering to be Public in which anyone can join.

In accordance with yet other exemplary embodiments, a user or users can setup a “piggy-bank” for each social gathering wherein a plurality of users contribute monies for sharing group expenses. In such an embodiment, as participants incur/upload expense receipts, monies are allocated from the “piggy-bank” to the individual incurring the expenses. Participants may be paid once the group approves payment to a participant. In yet another embodiment, the system enables Person-to-Person Money Transfers. For example, participants may upload expense receipts and select who is responsible for sharing the expenses. In this manner, participants can settle outstanding payments.

It is therefore evident that exemplary embodiments of the system described above enable a visual based communication platform for group decision-making comprising a collaborative and organized information exchange. The system enables a plurality of users each associated with a particular social gathering to ask questions, post answers, cast votes before a timer expires and the like. Such capabilities are enabled via a plurality of user interfaces and web pages that are visually engaging, intuitive, easy to use, collaborative, customizable, fun, and convenient.

The application of decision countdown timers to the decision making process creates a sense of urgency, increases effectiveness and promotes efficiency. As a result, the system may be beneficially applied to various forms of planning including, but not limited to, social planning, event planning, activity planning, vacation planning, holiday planning, trip planning, party planning, celebration planning, reunion planning, nightlife planning, concert planning, tradeshow planning, conference planning, festival planning, political campaign planning and special occasion planning. In accordance with other exemplary embodiments, the system may be beneficially applied to various forms of business enterprises including, but not limited to, external enterprises, such as marketing events, product surveys and customer surveys, and internal events, such as meetings, corporate retreats and employee surveys. Other applications include, but are not limited to game shows, reality shows and audience surveys, music fan surveys, celebrity fan surveys and the like.

While described herein, in accordance with various exemplary and non-limiting embodiments, with reference to planning and executing social gatherings, the embodiments described herein are not so limited. Specifically, exemplary embodiments are drawn broadly to encompass any and all uses of the elements and functionality described herein including, but not limited to, the use by businesses to perform product development research and/or customer engagement. For example, a music band may utilize the system to engage fans in a survey of questions for choosing concerts dates, cities to perform, album art, promotional products to create (i.e., hat, t-shirt designs) and the like. In another example, a celebrity may engage fans in a survey of questions for choosing which outfit and/or jewelry to wear to a red carpet event or what charitable foundation to support or when and where to hold a book signing. In yet another example, a brand may engage customers in a survey of questions for market research or product development. For example, a cosmetic company may survey what colors to offer in the coming season or a handbag designer may survey what size, shape and materials to use for new products.

In accordance with exemplary and non-limiting embodiments, the system may enable various monetization options. For example, home pages and their backgrounds may be branded and geo-targeted for advertising & sponsorships. In other examples, the interactive plan page may present or otherwise display “Partner” options and deals such as flights, hotels, cars/rails, cruises, travel deals, vacation packages, activities (e.g. golfing, whitewater rafting, etc.), event tickets (e.g., sports, concerts, theater, film, festivals, etc.), dining, consumer products (e.g. gifts, clothing, shoes, jewelry, books, music, video games, electronics, home & household, health & beauty, etc.), services (e.g. spa, bottle service, etc.), foundations (e.g. charitable, etc.), as well as sponsorships, affiliations and money transfer fees. The system may collect user data. User data may be usage data, decision data, purchase and transaction data, friends data, influence data, other statistical data, other analytics data, other reporting data, and the like. Usage data may include how often the user logs into the system, how active the user is when logged into the system, and the like. Decision data may be what choices a user may have made related to a single event, what decisions a user may have made related to a group of events, and the like. Purchase and transaction data may be how many purchases and transactions a user defines, initiates, completes, abandons and the like. Friends data may be how many friends a user has, how many friends a user invites, how many invitations a user receives from a friend, and the like. Influence data may include how many other users sign up for an event that the user creates or signs up for, how many other users complete a transaction that the user creates or completes, and the like. Other statistical data may include information used to calculate probabilities for the system on a per-user basis, on an aggregate user basis, and the like. Other analytics data may include information used to calculate analytical information for the system on a per-user basis, on an aggregate user basis, and the like. Other reporting data may include information used compile reports for the system on a per-user basis, on an aggregate user basis, and the like. In yet other embodiments, user data may be sold.

This disclosure further relates to a system and method for event promotion by businesses, event organizers, or the like (“event promoters’) using a web-based platform for enabling on-line planning among a pre-defined group of people, such as a group of friends, an affinity group, a fan club, a group of co-workers, a team, or the like, to plan and participate in an event being promoted. For example, the web-based platform allows users such as event promoters to create a public event plan web page to advertise and promote an event, and from which a user, such as a potential event participant, can create a private plan web page relating to the event to allow a group of potential event participants to interact with one another via the visual elements of the web page to engage in numerous facets of planning, such as described above, and to also perhaps complete a transaction related to the event.

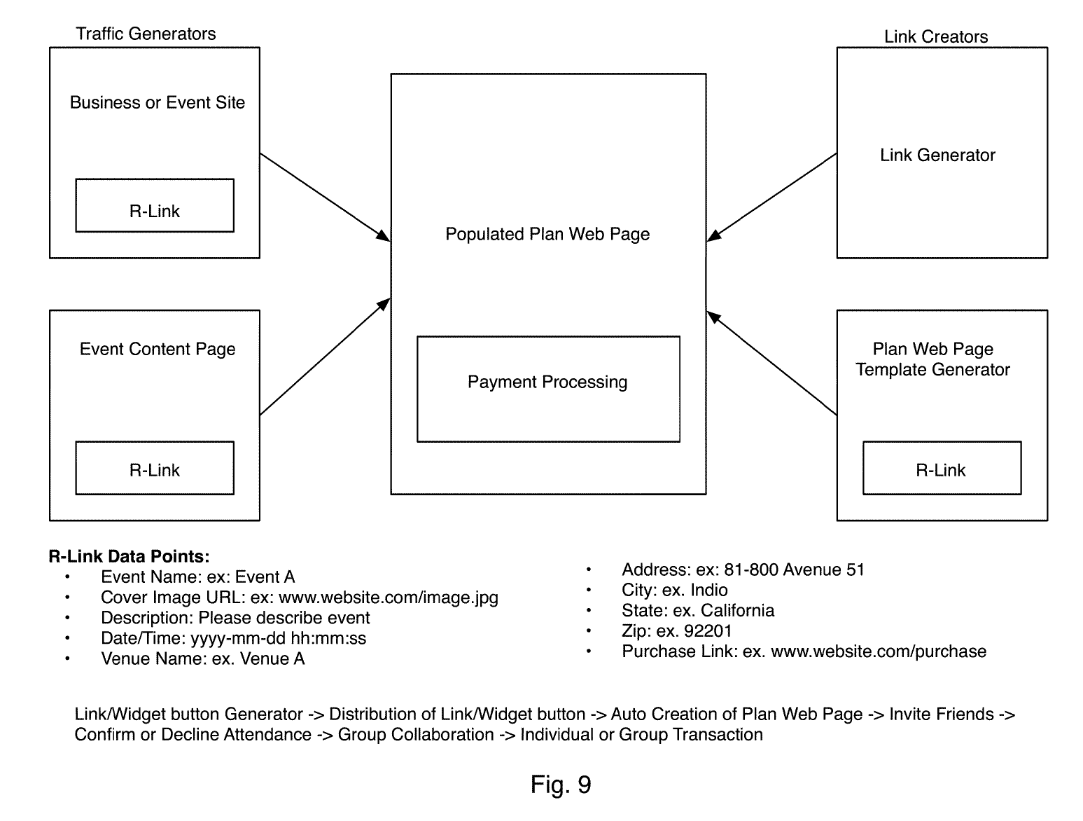

In particular, FIG. 9 illustrates one embodiment of such a system for event promotion and group planning, in which a plan template is accessed by an event promoter and populated to create a populated plan web page (“Populated Rundavoo” or “Rundavoo”) with details of an event, such as a visual representation of the attributes of the event, and possible times and dates for the event, and an option to execute event-related transactions, either on the populated plan web page directly, or by selecting a link to a partner website. The event related transaction may include a ticket purchase, transportation booking, lodging booking, dining booking, and the like. Generally, the boxes on the right in FIG. 9 represent the tools used to generate the Populated plan web page (Populated Rundavoo) template as well as the links to point traffic to the Populated plan web page (Populated Rundavoo), called “R-Links” Further, the boxes on the left in FIG. 9 represents how user traffic can be directed by different sources and then fed to a Populated plan web page (Populated Rundavoo) in the middle.

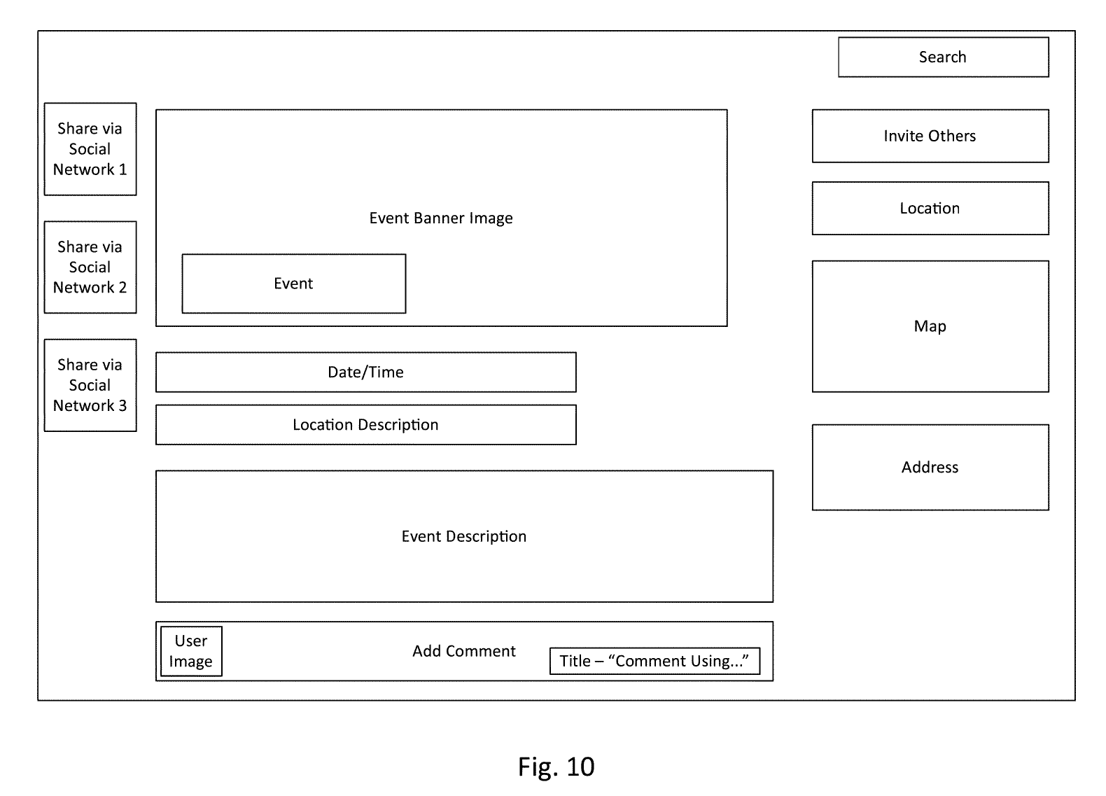

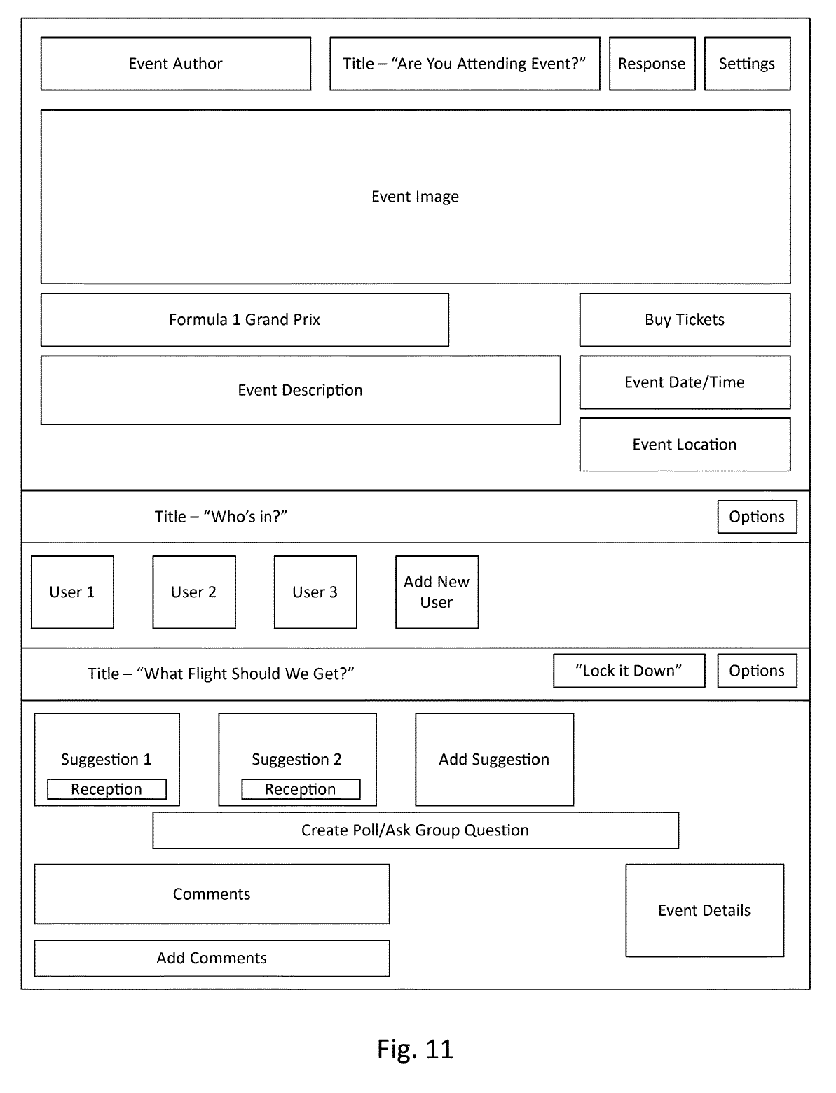

FIGS. 10 and 11 illustrate embodiments of populated plan web pages. The populated plan web page may include event specific information such as the date of the event, time of the event, location of the event and the like. The populated plan web page may include links to social networks such as Facebook, Twitter, Google+, and the like. The populated plan web page may display a list of visitors that will be attending the event. The populated plan web page may allow visitors to make decisions related to the event, such as choosing a flight to the event, and the like. The populated plan web page may allow visitors to indicate their attendance. The populated plan web page may allow visitors to execute a transaction related to the event, such as purchasing tickets related to the event, and the like. The populated plan web page may allow visitors to the populated plan web page to comment on the event. The populated plan web page may include a Link/Widget button that allows visitors to generate their own private web plan web pages and share the private web plan web pages with friends, allowing friends to sign-up for the event, providing a multiplication effect on the number of visitors to the public and private plan web pages.

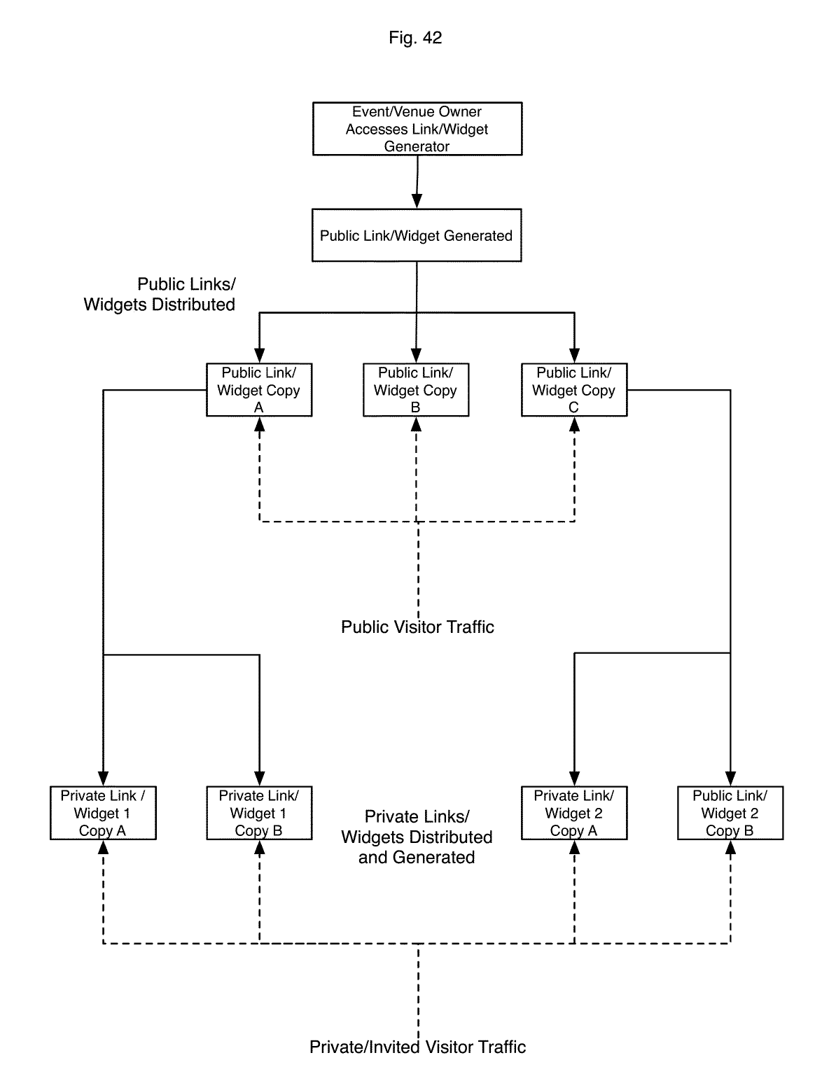

Referring now to FIG. 42, an event promotion process, through the use of link generation and facilitation of group event planning, helps businesses increase traffic to specific web pages promoting various events, helping to lower the cost of acquiring customers. The ease of use of the provided LINK/WIDGET button allows users to easily organize a group activity or event and coordinate all aspects of participation. As shown in FIG. 42, a single Public plan web page, generated by an event or venue owner using the Link/Widget button, can be distributed as multiple copies of the public plan web page, creating multiple collection points for public visitor traffic. The ease of distribution provided by information made accessible by a URL/link allows an event or venue owner to easily distribute these multiple copies of the Public plan web page, illustrated in FIG. 42 as Public Plan Web Page A, Public Plan Web Page B, Public Plan Web Page C. As further shown in FIG. 42, each copy of each Public plan web page allows visitors to the Public plan web page to generate multiple copies of a Private plan web page, generated by a Link/Widget button. The ease of distribution provided by information made accessible by a URL/link allows a visitor to a private plan web page to easily distribute these multiple copies of the Private plan web page, illustrated in FIG. 42 as Private Plan Web Page Copy A, Private Plan Web Page Copy B, Private Plan Web Page Copy A, and Private Plan Web Page Copy B.

Distribution of a plan web page may originate from and be made to, a wide range of environments. For example a provider of services, such as trip planning, hotel booking, transportation, or ticketing services, may allow creation of a plan web page using a Link/Widget button as described herein within the interface (e.g., a web site) of the service provider, such that a proposed plan web page for an event may originate within that environment and be distributed to other environments. For example, a user might initially review upcoming events in a ticketing site, then, within that site, create a plan web page using a Link/Widget button that is distributed to the user's social network for commentary among a decision-making group. The plan web page generated using The Link/Widget button might be modified and/or copied for distribution to other environments, such as to a site for booking travel to an event. Thus, the plan web page generated using the Link/Widget button may be carried through different environments, allowing collaboration among the decision-making group about selecting an event to attend (e.g., at a concert or sporting event site), arranging to travel together to the event (e.g., at an airline site), arranging to stay at the same accommodations (e.g., at a hotel services site), and arranging to dine together (e.g., at a dining services site). The plan web page generated using The Link/Widget button may be integrated, as noted above, with the transactions infrastructure of each of a range of third party services, so that once consensus is reached on an aspect of an event (the event, date, travel, accommodations, related services, etc.), the booking or purchase of the related services can be executed seamlessly, either facilitated (such as through an API) from the plan web page generated using the Link/Widget itself, or by handoff to the transaction infrastructure of the environment of a service provider within which the plan web page generated using the Link/Widget resides.

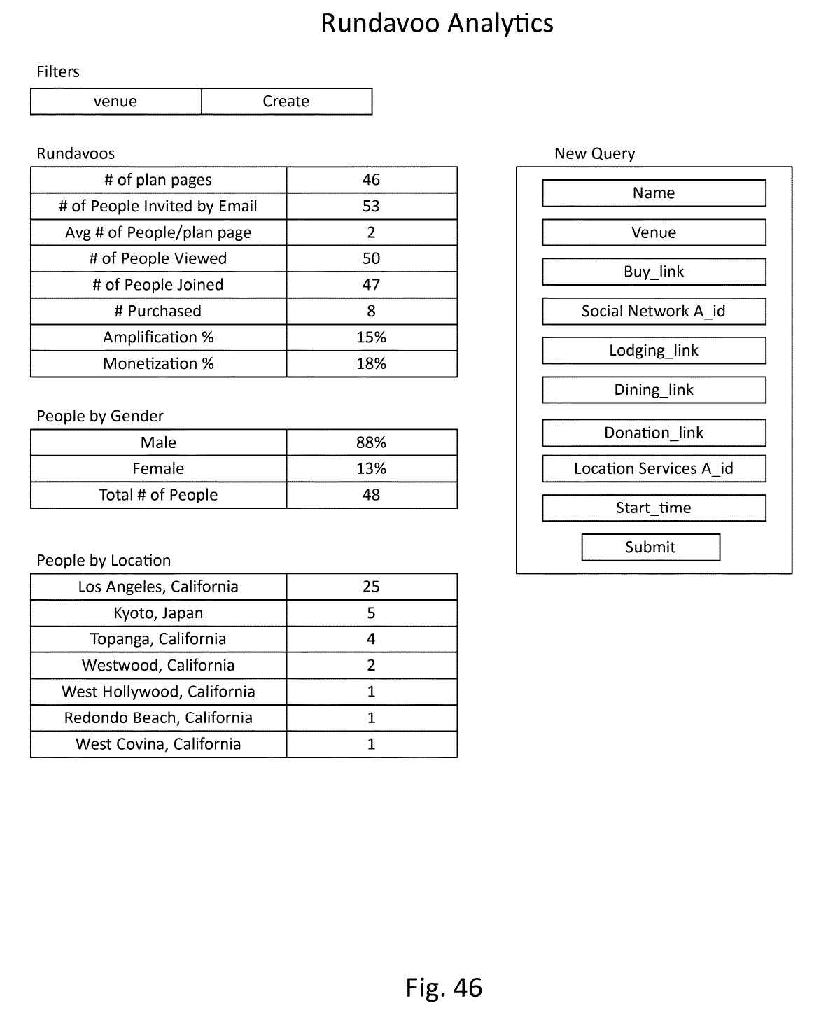

As shown in FIG. 46, analytic and reporting data related to the Link/Widget button may be available. Such data may include filter data, plan pages or Rundavoos data, people data, and the like. Filters data may include name data and the like. Plan pages or Rundavoos data may include number of plan pages or Rundavoos, average number of people per plan page or Rundavoo, number of people who viewed a plan page, number of people who joined an event or gathering, number of people who purchased something, and the like. People information may include gender and location information. Gender information may include the number or percentage of males, the number or percentage of females, total number of people, and the like. Location information may include city, state, country, and the like. Analytic and reporting data may be available for download or export from the system.

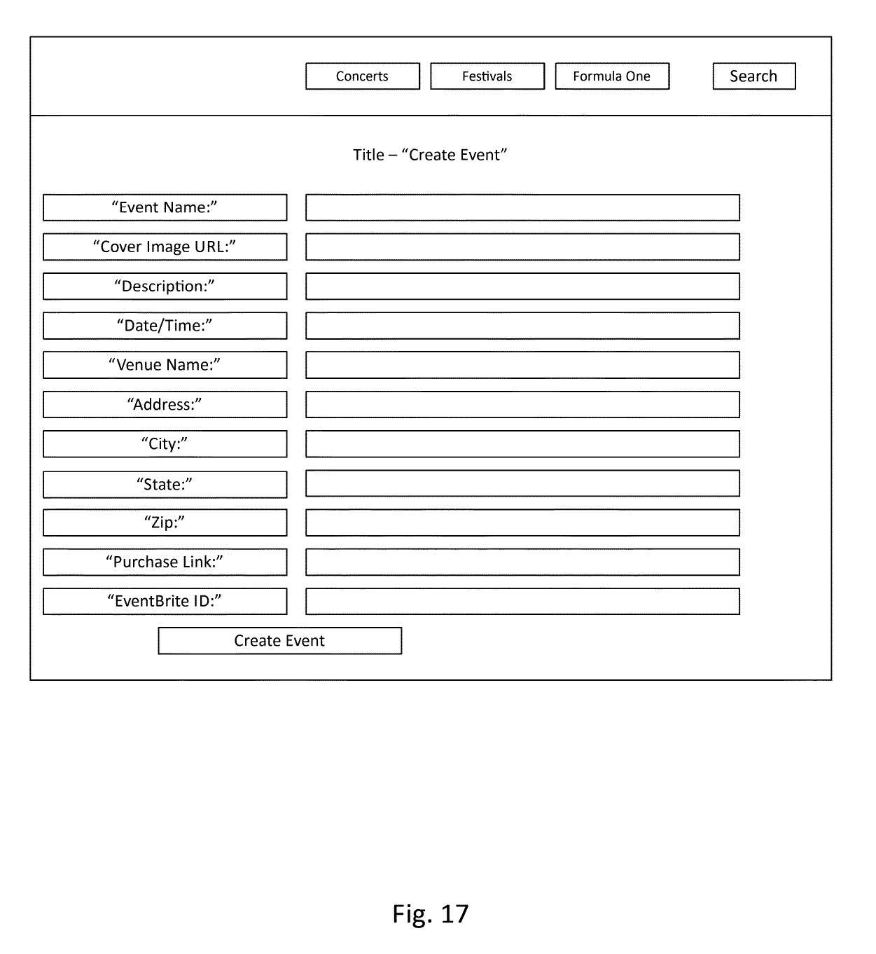

More specifically with respect to the steps above, to generate an event template and link, a user such as an event promoter can access a Link/Widget button generation web page. In some embodiments, access to the Link/Widge button generation web page can be done via various forms of authentication, such as allowing a user to input user credentials associated with other websites (e.g. Facebook, Twitter, LinkedIn, Google, etc.), in a manner such as is provided by a service like https://www.loginradius.com/. In some embodiments, the user can enter event information into a form on the Link/Widget generation web page. Event information may include event logistic information, event specific information, as well as event integration information, and the like. With respect to FIG. 17, such event logistic information can include for example: Event Name, Event Image URL, Event Description, Date/Time, Venue Name, Street Address, City, State, Zip Code, and Purchase Link (or Transaction Link). Event specific information may include event name, cover image URL, description, date/time, venue name, address, city, state, and zip code, and the like. Integration information may include information required to integrate with third-party services. Third party services may include ticket purchasing services, transportation booking services, lodging booking services, dining booking services, other reservation booking services, or the like. Information required to integrate with third party services may include links to the third party service, login information for the third party service, other identification for the third party service, or the like.

This information can be entered into the Link/Widget button generation web page by a variety of parties including, but not limited to: business owners, event holders, and Rundavoo staff. This information may be managed via a secured form. Access via the secured form allows a party to change or update the event and transaction information associated with the Link/Widget button, using the Link/Widget generation web page, without requiring the help of a technical resource. Access via the secured form allows parameters of the Link/Widget button to be easily changed or updated, which allows the same Link/Widget button to be used to promote subsequent events without having to regenerate a new Link/Widget button for each event or require that the Link/Widget button be removed from a website when an event expires, for example. A default destination location can be configured for the Link/Widget button to send any user who clicks on the Link/Widget button after the event has passed to be sent to a different URL, i.e. In some embodiments, a user can bypass the Link/Widget button generation web page and create a Link/Widget button simply by passing a URL to Rundavoo. In this case, the information that would have been entered in the link/Widget button generation page would simply be passed as arguments within the URL.

Once the information is entered and submitted, the platform will create a Link/Widget button with the event information embedded in it, which can be accessed via the link (R-link) Link/Widget button created by the platform. In some cases, the Link/Widget button can be integrated directly or indirectly with many other web services, such as Foursquare and Eventbrite. Web services may include ticket purchasing services, transportation booking services, lodging booking services, dining booking services, activity booking services, other ticket booking services, other transaction-based services, other reservation-based services, donation collection services, other web services or the like. Transportation booking services may include orbitz.com, kayak.com, travelocity.com, expedia.com, cheapflights.com, hotwire.com, amtrak.com, megabus.com, boltbus.com, greyhound.com, peterpanbus.com, delta.com, united.com, aa.com, britishairways.com, southwest.com, emirates.com, avis.com, enterprise.com, uber.com and the like. Lodging booking services may include transportation booking services that also provide lodging booking services, hotels.com, booking.com, bookit.com, spg.com, marriott.com, hilton.com, ritzcarlton.com, mandarinoriental.com, choicehotels.com, and the like. Dining booking services may include opentable.com, savored.com, and the like. Activity booking services may include golfnow.com, meetup.com, and the like. Other ticket booking services may include eventbrite.com, ticketmaster.com, stubhub.com, livenation.com, and the like. Other transaction-based system web sites or web pages may include apple.com/itunes, amazon.com, Nordstrom.com, and the like. Donation collection services may include clickandpledge.com, blackbaud.com, wwwactivegiving.com, www.donortools.com, and the like. Donation collection services may include clickandpledge.com, blackbaud.com, www.activegiving.com, www.donortools.com, and the like. Other web services may include Foursquare.com and the like.

The other web services may be directly integrated, indirectly integrated, and the like. A directly integrated web service may display its content directly on the plan web page and allow the user to interact with the content, such as complete a transaction, without having to leave the plan web page. The content of an indirectly integrated web service may be accessed when a user clicks on a link that has been displayed on the plan web page. The user is then taken to a third-party site where the content of the indirectly integrated web service is displayed. The user can then interact with the content, such as complete a transaction, on the third-party site.

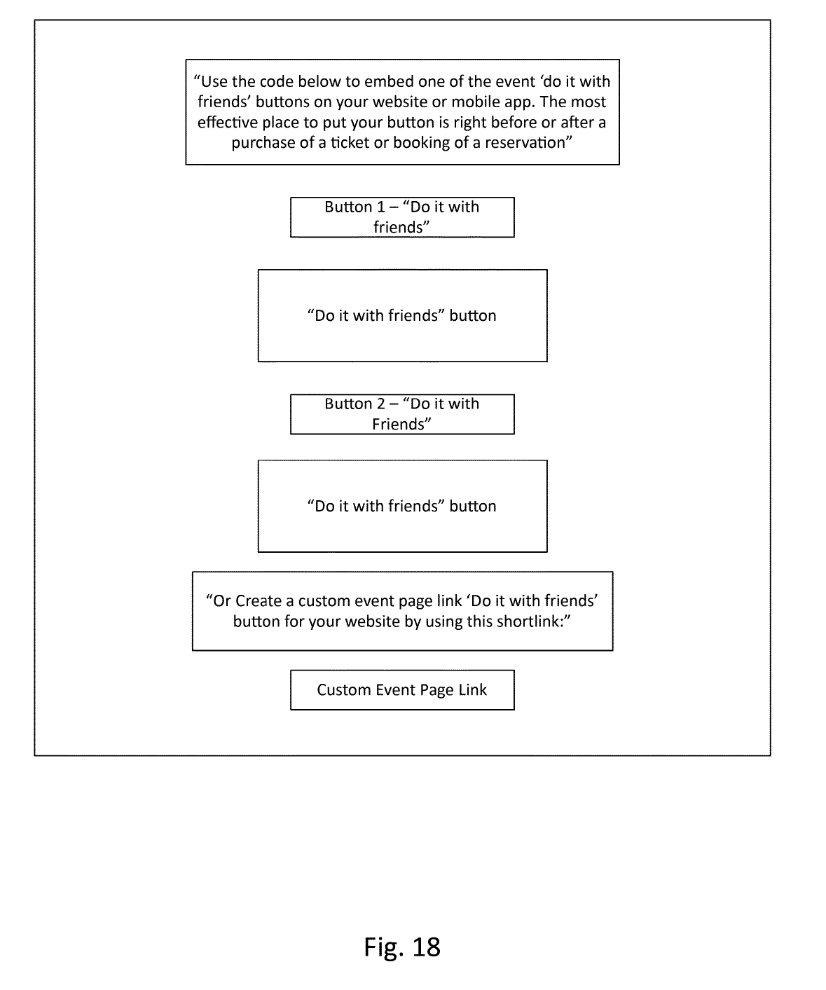

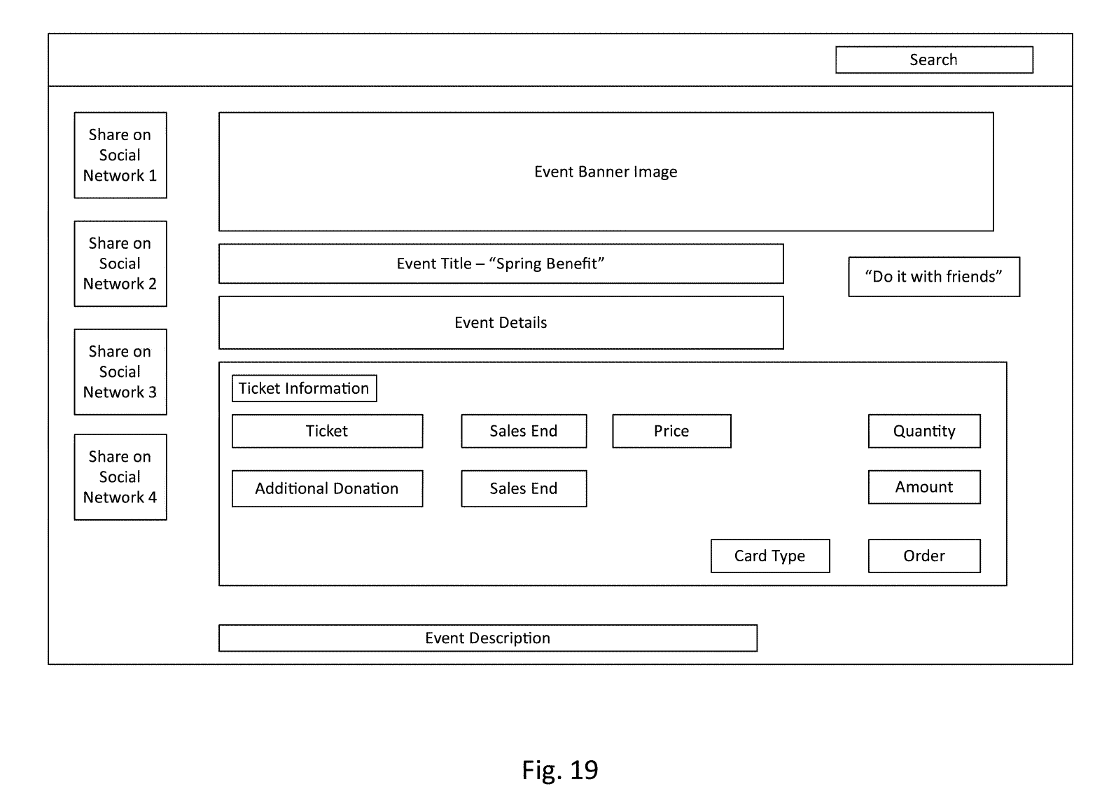

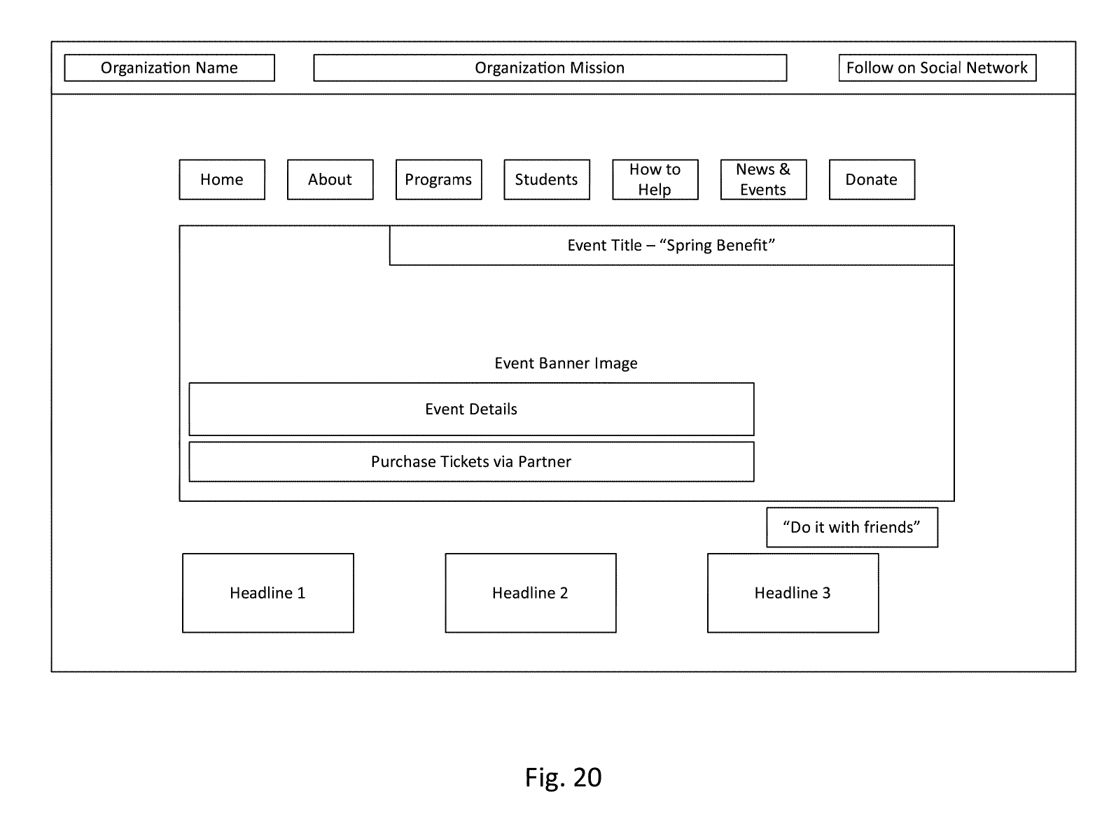

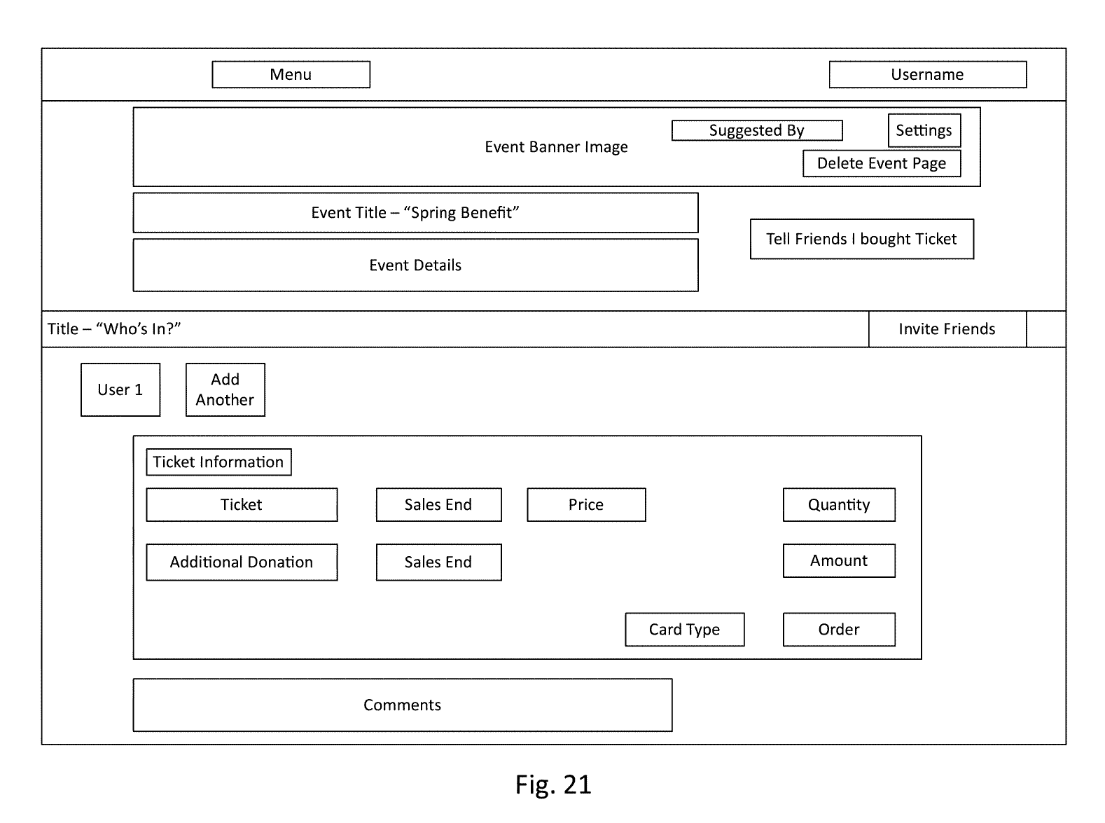

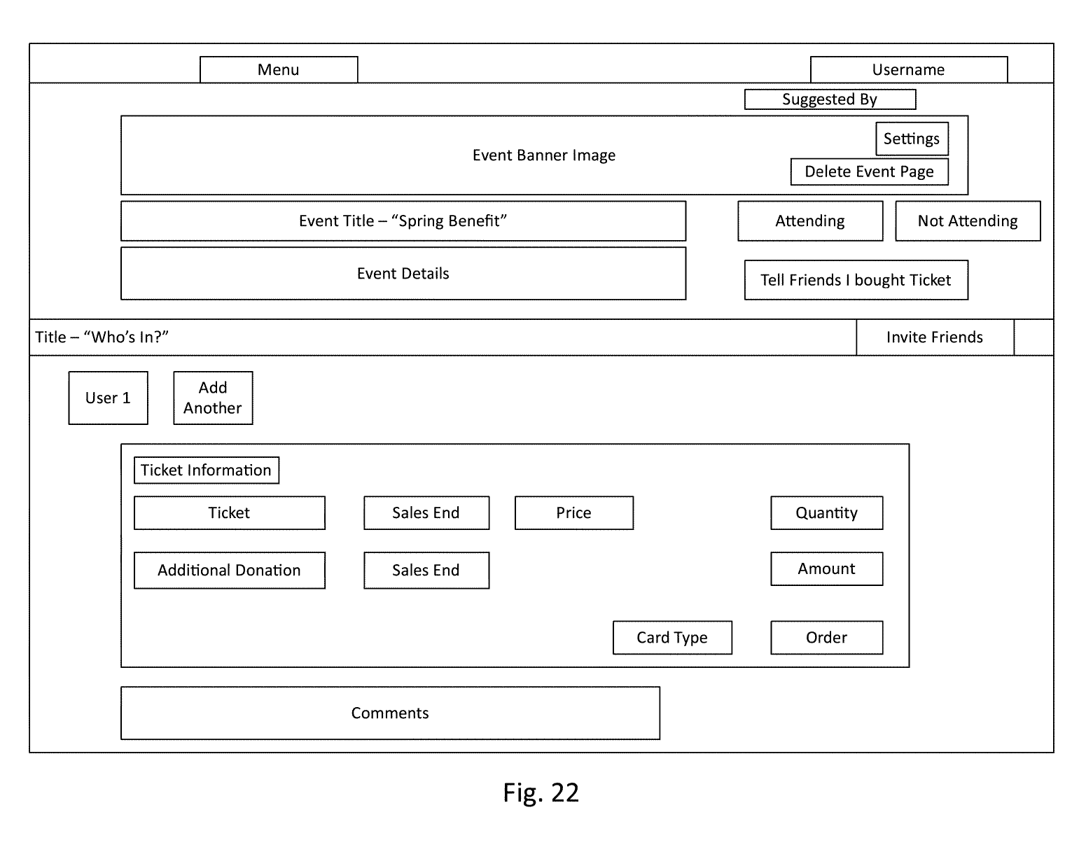

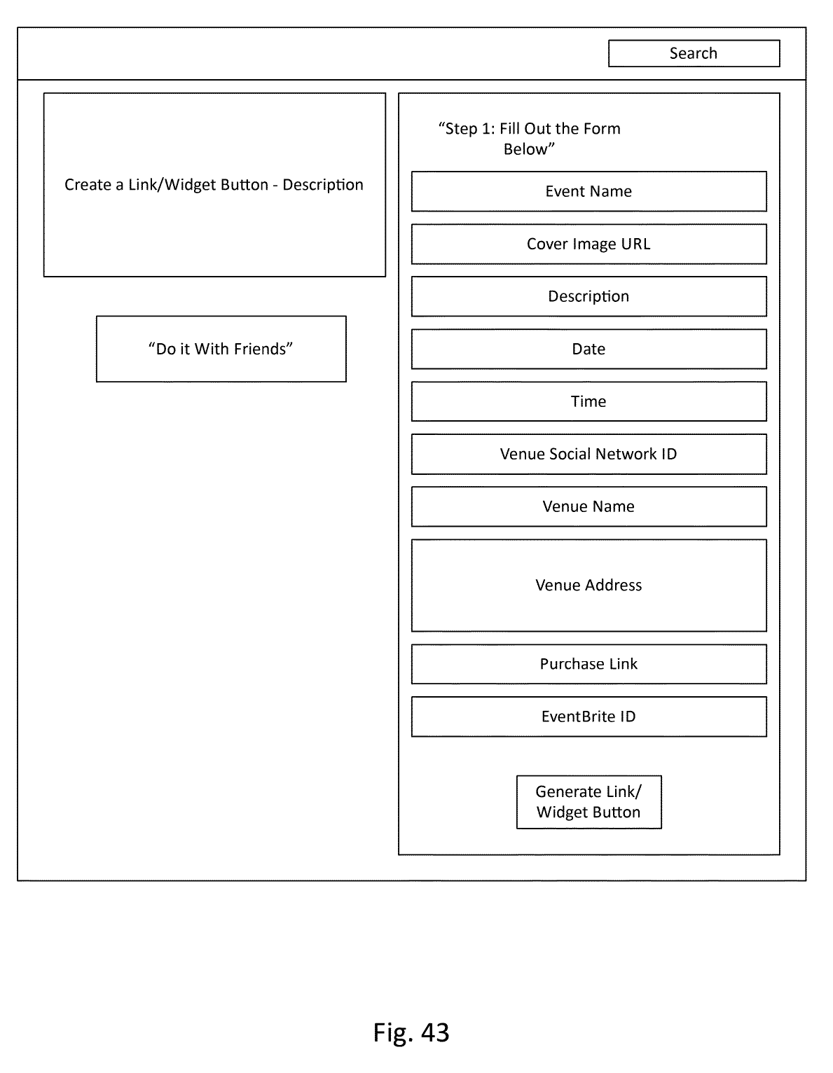

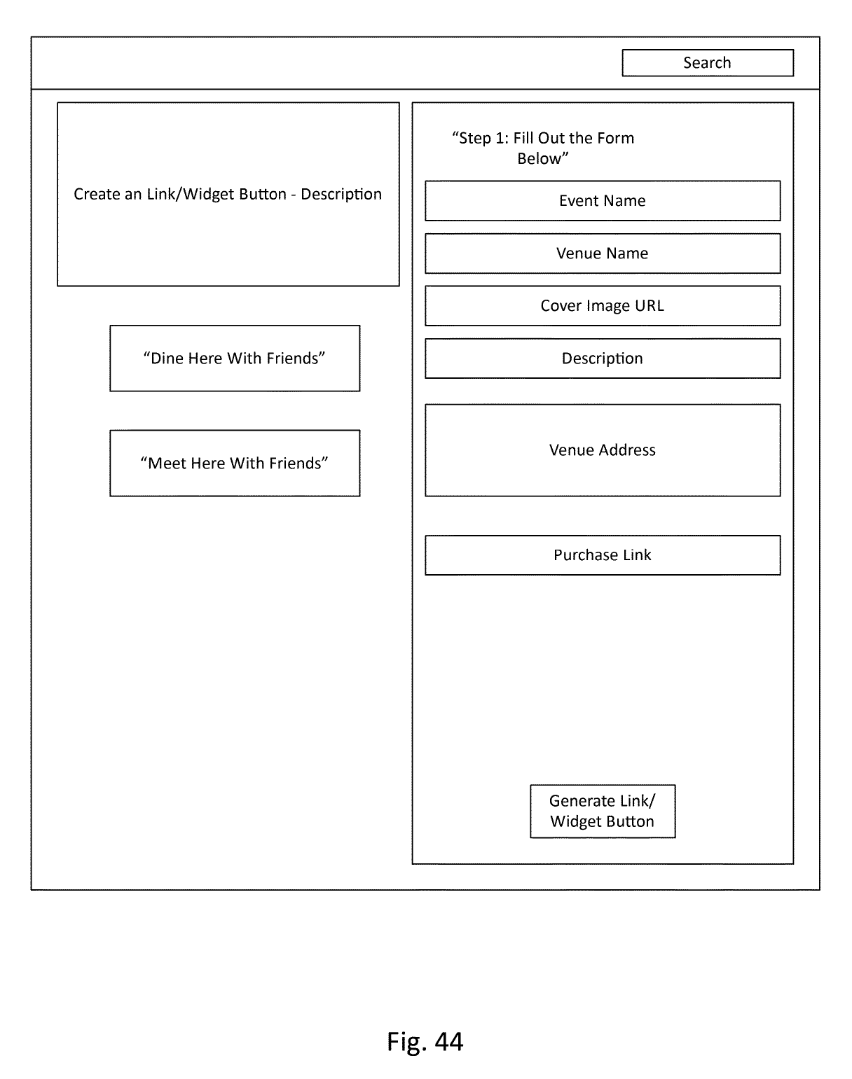

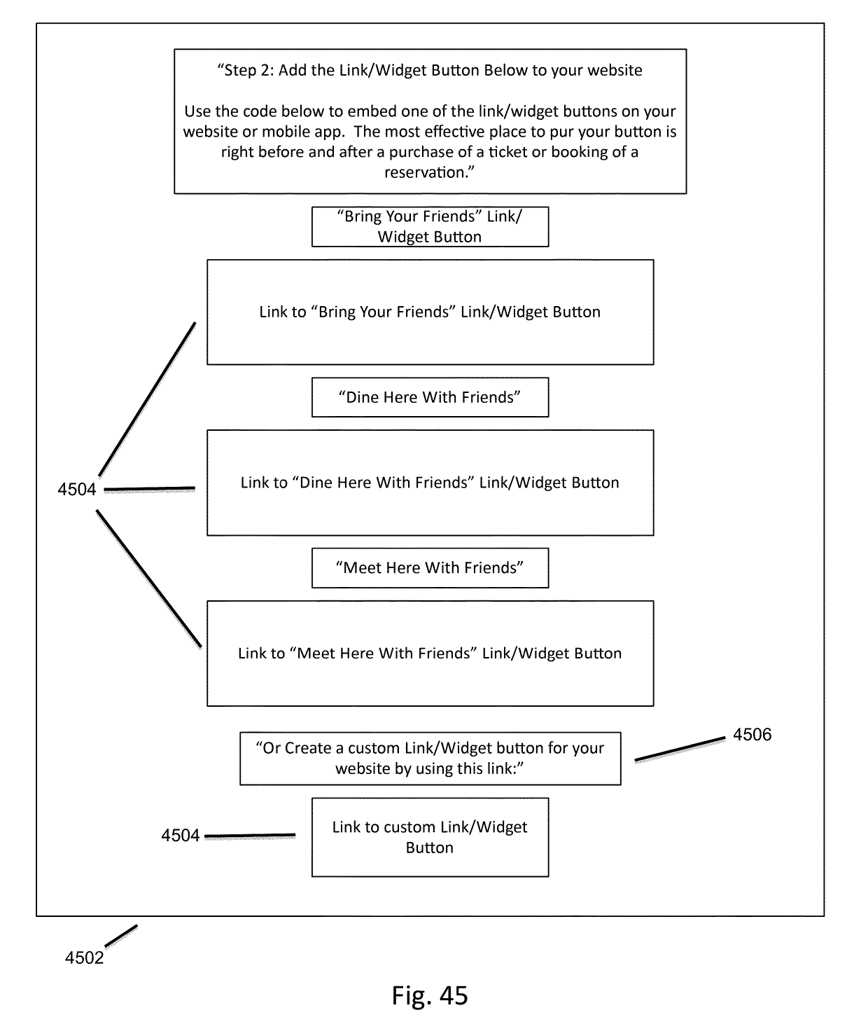

In general, an exemplary event promotion process can be described as follows:
1. An organizer such as an event/venue owner accesses a Link/Widget generation web page and completes a form, such as the form illustrated in FIG. 17. The Link/Widget generation web page allows the event/venue owner to enter event specific information. Event specific information may include event logistic information, as well as event integration information, and the like. Event logistic information may include event name, cover image, URL, description, date/time, venue name, address, city, state, and zip code, and the like. Event integration information may include information required to integrate with other web services such as ticket purchasing services, transportation booking services, lodging booking services, dining booking services, an auxiliary or related event, or other reservation services, or the like. Information required to integrate with other web services may include links to the other web service, login information for the other web service, other identification for the other web service, and the like.
2. Using a web page such as illustrated in FIGS. 18, 43, 44, and 45, the organizer creates or facilitates the creation of a public Rundavoo, an example of which is illustrated in FIG. 19. A public Rundavoo is a public plan web page which includes an embedded Link/Widget button. In this example, the embedded Link/Widget button says “Do it with Friends”, and is integrated with a ticket purchasing web service, where the ticket purchasing service is integrated with the public plan web page that has been generated by the organizer.
   FIGS. 43 and 44 illustrate a form 4302 that may be used by the organizer to generate an event link button 4304. Form 4302 may allow the organizer to make it easy for an organizer to increase traffic to the event of the organizer at no cost to the organizer. Form 4302 may allow the organizer to generate event link button 4304 in two process steps. From 4302 may allow the organizer to enter event related data. Event related data may include event name, cover image URL, description, date, time, venue Foursquare ID, venue name, address, purchase link, EventBrite ID, and the like. Address may include street name, city, state, zip code and the like. Form 4302 may include a generate button 4306. Clicking generate button 4306 may generate event link button 4304. Event link button 4304 may include a title. Title may be do it with friends, bring your friends, dine here with friends, meet here with friends, and the like.
   FIG. 45 illustrates an interface 4502 which may allow an organizer to add event link button 4304 to the website of the event, organizer, and the like. Interface 4502 may include event link buttons 4304 and event link button source code 4504. Event link button source code may be embedded by organizer into the website of the event, organizer, and the like to add link button 4304 to the website. Source code 4306 may include source code to create an event link button 4304 or a custom event link 4506.
3. The organizer distributes the public plan web page information, such as to their customers or to other individuals or websites as desired, such that other public plan web pages can be generated, such as the one illustrated in FIG. 20. The distribution of the public plan web pages facilitates the collection of additional potential attendees, by multiplying the number of sites that can attract such attendees.
4. The organizer, recipients of, or visitors to the public plan web page invite friends through the creation of private plan pages or private Rundavoos, such as the private plan web pages illustrated in FIG. 21, which are accessible to a pre-defined group of people and define a group gathering related to the event, and may include direct integration with a ticket purchasing service, where the ticket purchasing service is directly integrated with the private plan web page that has been generated by the organizer, as illustrated in FIG. 21. The generation of private plan web pages also facilitates the collection of additional potential attendees, by multiplying the number of sites that can attract such attendees. The private plan web pages are sent to a defined group of people, typically with some association with the generator of the private plan web pages, which also increases the likelihood that a visitor to one of the private plan web pages becomes a participant in the event being promoted by the private plan web page.
5. The group members confirm or decline attendance. For example, as illustrated in FIG. 22, the private plan web page or private Rundavoo includes buttons to indicate who is in and out. The group can also collaborate on any decisions that may need to be made related to the group gathering.
6. Individuals or a group execute one or more transactions, such as buying tickets to the event, booking transportation reservations, booking lodging reservations, booking dining reservations, booking other reservations, making donations and the like. For example, an Order Now button on the private web page such as illustrated in FIG. 22 can be used to facilitate such a transaction through direct integration of a booking service into the environment where the plan web page is hosted, through a link to the other web service, and the like.
7. Individuals can let group members know when they have executed a transaction via the plan web page, also as illustrated in FIG. 22.

In some embodiments, a WordPress content management platform hosted by Godaddy or other web hosting provider is utilized as the web platform. For example, a link/widget button or plan web page can be hosted on tickets.rundavoo.com, a subdomain of Rundavoo (i.e., rundavoo.com).

Specifically, users such as event promoters can generate, as illustrated in FIG. 42, a so-called public plan web page or public Rundavoo, which is accessible to the public (or other targeted group), which can include information and purchasing links related to the event, and which includes a link or ability for a group to create, as illustrated in FIG. 42, a so-called private plan web page or private Rundavoo, which is a private web page accessible by invitation describing a group gathering related to the event. The private plan web page or private Rundavoo can also facilitate group collaboration, such as described above with respect to FIGS. 1-8, and elaborated upon below with respect to FIG. 11 for items related to the event. For example, an event organizer can generate a public event plan web page for a concert or a racing event, and visitors to the public plan web page can generate their own private plan web page for a group gathering related to the event, which is accessible by a private defined group. This private plan web page can include information and/or purchasing links to one or more other websites or web pages associated with the event itself (such as to buy tickets for the event) and for other planning associated with the social gathering, such as which tickets to buy, or additional logistics decisions related to the event. Other web sites or web pages may include ticket purchasing web sites or web pages, transportation booking web sites or web pages, lodging booking web sites or web pages, donation collection services, dining booking web sites or web pages, activity booking web sites or web pages, other ticket booking web sites or web pages, other transaction-based system web sites or web pages, other reservation-based web sites or web pages, other web sites or web pages or the like. Transportation booking web sites or web pages may include orbitz.com, kayak.com, travelocity.com, expedia.com, cheapflights.com, hotwire.com, amtrak.com, megabus.com, boltbus.com, greyhound.com, peterpanbus.com, delta.com, united.com, aa.com, britishairways.com, southwest.com, emirates.com, avis.com, enterprise.com, and the like. Lodging booking web sites or web pages may include transportation booking services that also provide lodging booking services, hotels.com, booking.com, bookit.com, spg.com, marriott.com, hilton.com, ritzcarlton.com, mandarinoriental.com, choicehotels.com, and the like. Dining booking services may include opentable.com, savored.com, and the like. Activity booking web sites or web pages may include golfnow.com, meetup.com and the like. Other ticket booking services may include fandango.com, eventbrite.com, ticketmaster.com, stubhub.com, livenation.com, and the like. Other transaction-based system web sites or web pages may include apple.com/itunes, amazon.com, nordstrom.com, and the like. Donation collection services may include clickandpledge.com, blackbaud.com, www.activegiving.com, www.donortools.com, and the like. Other web sites or web pages may include Foursquare.com and the like.

The other web sites or web pages may be directly integrated, indirectly integrated, and the like. Directly integrated web sites or web pages may display content directly on the plan web page and allow the user to interact with the content, such as complete a transaction, without having to leave the plan web page. The content of an indirectly integrated web site or web page may be accessed when a user clicks on a link that has been displayed on the plan web page. The user is then taken to a third-party site where the content of the indirectly integrated web site or web page is displayed. The user can then interact with the content, such as complete a transaction, on the third-party site.

In this regard, another example public plan web page is illustrated in FIG. 10, and includes various ticket buying options for an event. Further, this public plan web page includes an option to create a private plan web page, such as by use of a “Bring your Friends” button or an “Invite Others” button such as illustrated therein, wherein a private plan web page defining a social gathering relating to the event can be created to be accessed. Multiple copies of the private plan web page can then be easily distributed, as illustrated in FIG. 42, providing multiple collection points for private visitor traffic.

An embodiment of another private plan web page or private Rundavoo is illustrated in FIG. 11 for a social gathering related to a Formula I Grand Prix event. This private Rundavoo facilitates on-line planning for a group and includes collaboration tools in addition to those described above with respect to FIGS. 1-8. In particular, the illustrated web page can include features such as a lockdown button, a buy button, and a comments section. The illustrated example lockdown button includes the text “Lock It Down”, and allows an organizing user to prevent other users from voting on or making additional suggestions to a question, such as the illustrated question “What flight should we get?” When an answer is locked, it is displayed as the decision for that particular question and highlighted for the group (displayed at the top of the plan page), and no additional answers can be suggested at that point. The lock can be turned on or off at will by the organizing user. When the lock is turned off, users can suggest additional answers and vote again. The answer that is locked can also be based on a number of votes, an organizing user's preference, or the like.

The plan web page can also include one or more buy buttons with links to external websites (each buy button associated with an individual link), which allow users to take actions essential to participating in the plan. In the illustrated example, the “Buy Tickets Now” button links to an affiliate selling Grand Prix tickets. Other buy button links could also be included, for example, to link to tickets on stubhub.com, make dinner reservations on opentable.com, make a flight reservation on kayak.com, or book a hotel room on hotels.com. These links can be generated by the Rundavoo platform or manually created by users.

A comments section of a plan web page allows users to share comments with the group, such as at the bottom of the plan web page. The user making each comment can be represented by a name and an image. These can be supplied by Rundavoo's user account data or the Facebook API from Facebook Inc. of Menlo Park, Calif. Comments can be highlighted by the organizer, which can change their experience and/or move them to a position of prominence.

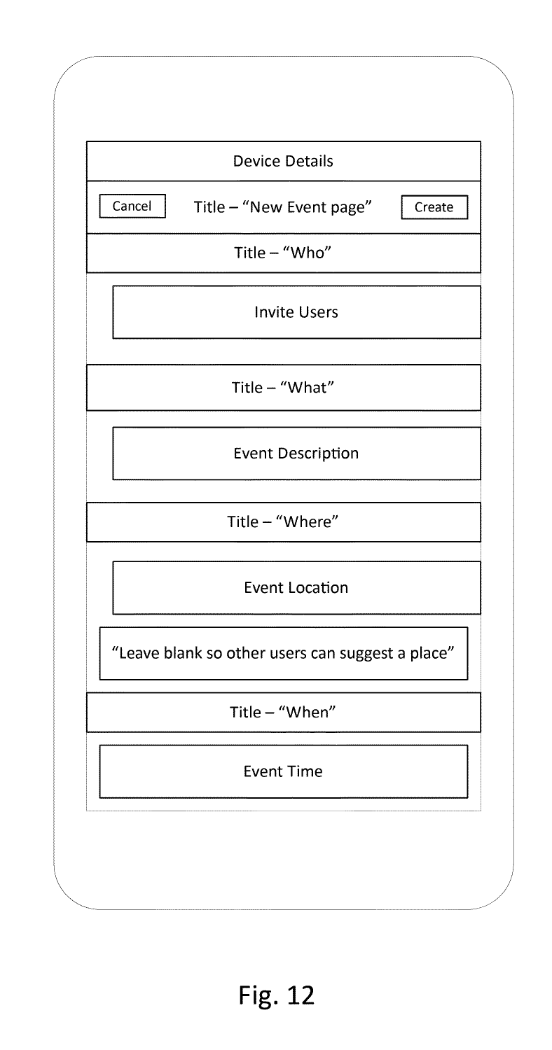

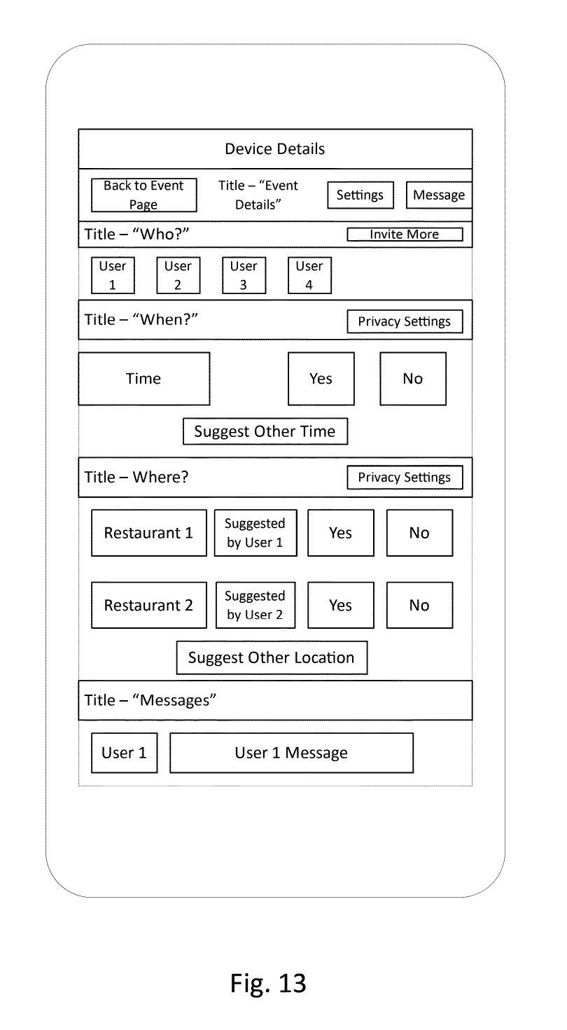

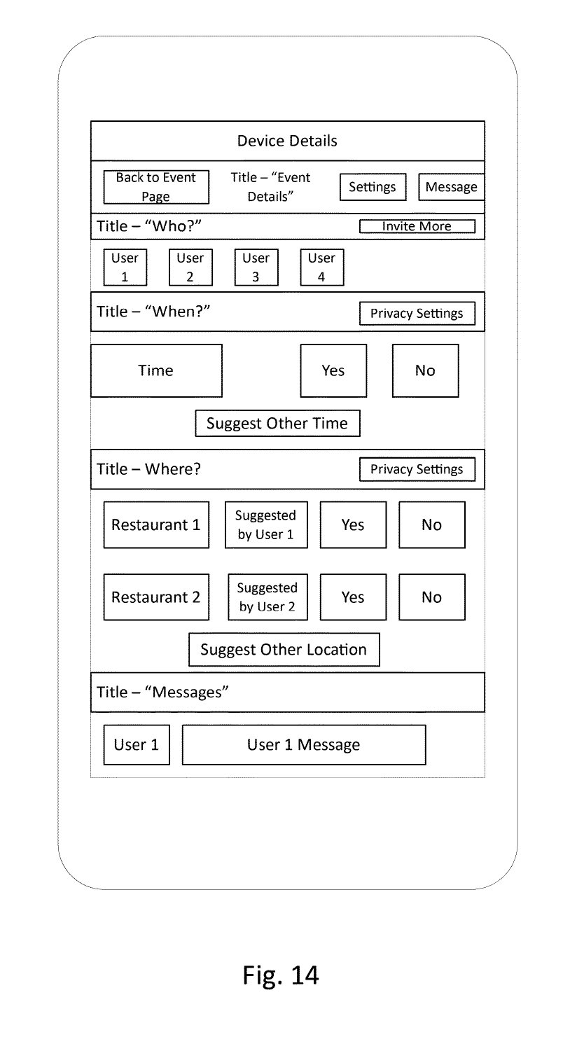

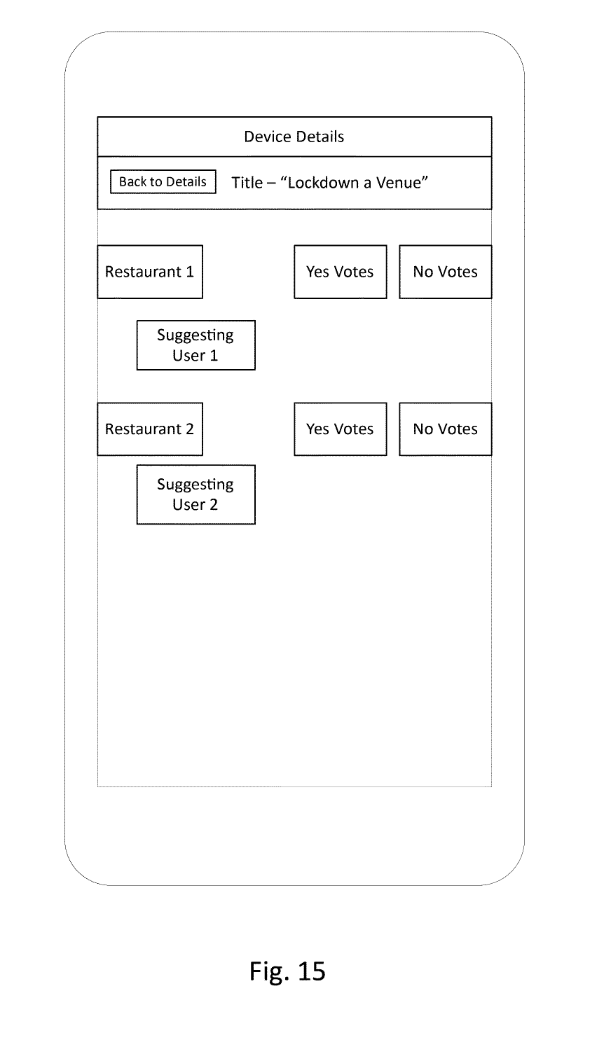

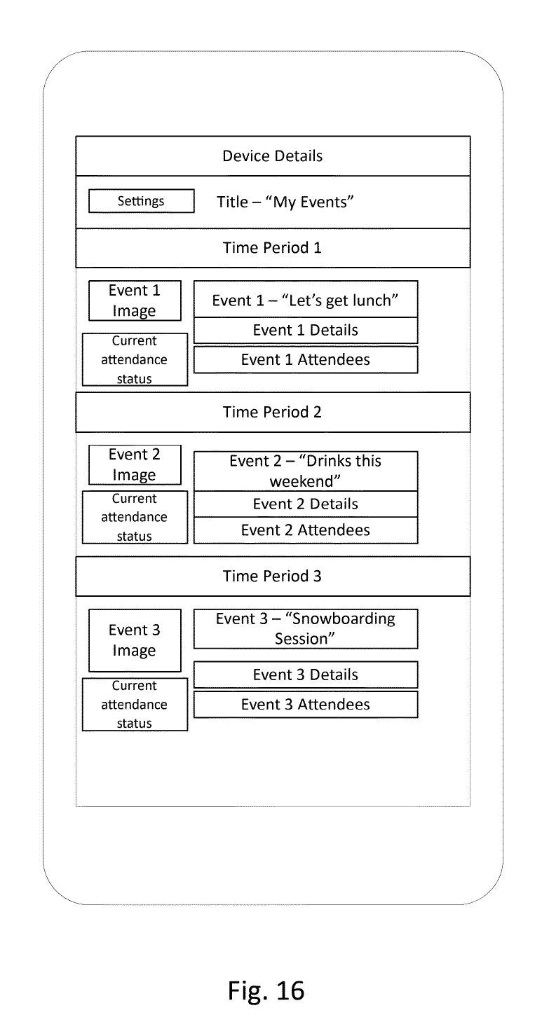

FIGS. 12-16 illustrate a mobile application for creating and using a Rundavoo. In general, as discussed above, the process includes initiating an event, inviting friends, and suggesting and collaborating on details, such as time and place. The application allows for the addition and communication of group member comments, and for selected comments to be highlighted for the group. The details of the event can be locked down, and the members can indicate whether they are in or out. The application also allows for a convenient way to keep track of all events in one place.

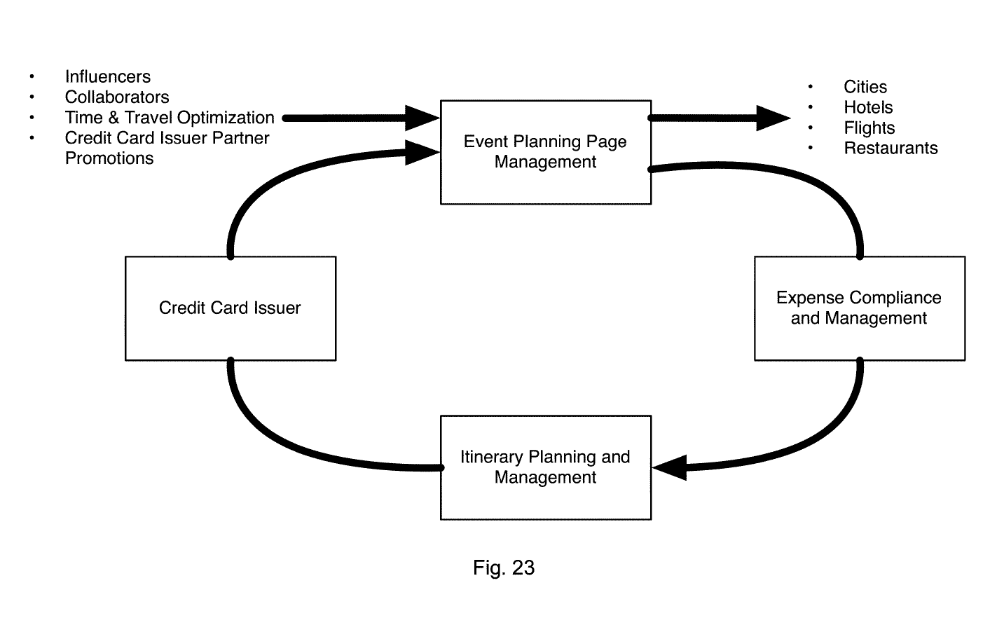

FIG. 23 is a diagram of the integration of an event/group planning tool such as Rundavoo with other travel, expense management and compliance, and payment tools. In this example, Rundavoo event planning is integrated with a travel booking and expense management and compliance tool (such as Concur—as described at www.concur.com), an itinerary organizer and travel plan manager tool (such as Tripit—as described at www.tripit.com), and a payment processor (such as American Express).

In such a system, the event planning tool can be used to manage corporate business travel plans in a manner, such as described above, to allow users to connect, collaborate and decide on various aspects of business travel. These users can plan which cities to travel to, which hotels to stay at, which flights to take, which cars to rent, which restaurants to go to, etc. This tool facilitates planning the what, when, and where of business travel, and can also be modified to provide options that comply with company travel policy as well as preferred merchants and partners (such as American Express merchants and partners in the illustrated example).

A travel booking tool can then be used for users to book their decided upon travel itineraries. Concur is also a tool which allow expenses to be captured so that business travellers can reduce the time they spend recording and accounting these expenses. For example, Concur includes automatic payment capability for electronically transferring payments to corporate card vendors and reimbursements to employees. Additional features include the ability for manager to verify line item expenses against submitted receipts, ensuring compliance, while reducing the risk of fraud.

A further tool which can be integrated in this system is a travel itinerary organizer, such as Tripit, which allows trip details to be organized into one master online itinerary to ensure that a user has all pertinent information organized and made accessible on a per-trip basis.

A payment processor tool can also be included. For example, American Express can perform this function, and benefit from the system as well by promoting merchant and travel partners, increasing issued credit card adoption, and adding value for both merchant and business card accounts.

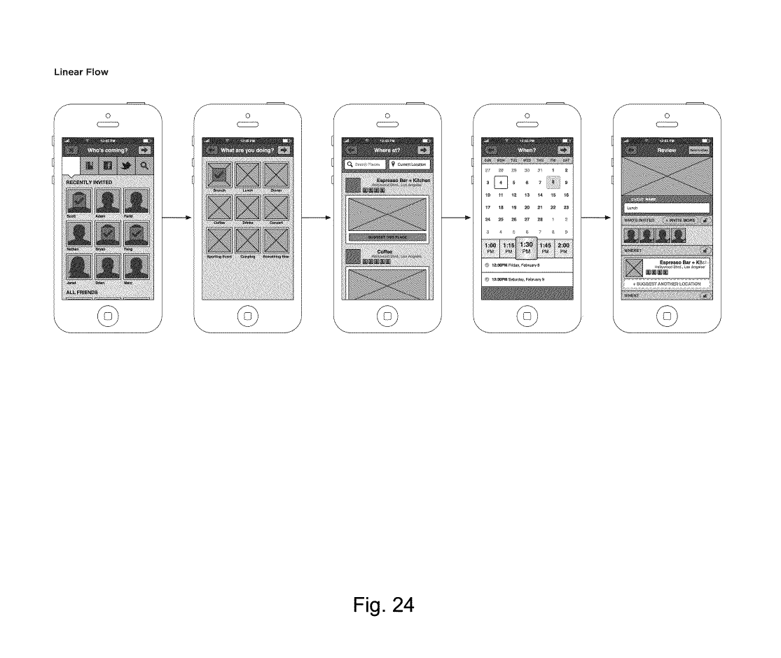

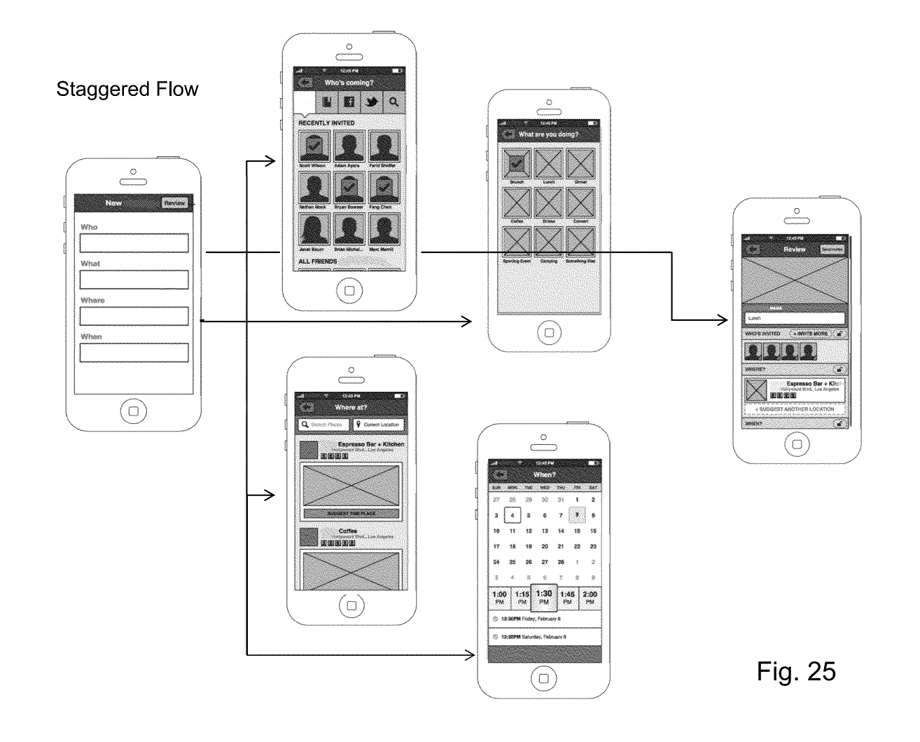

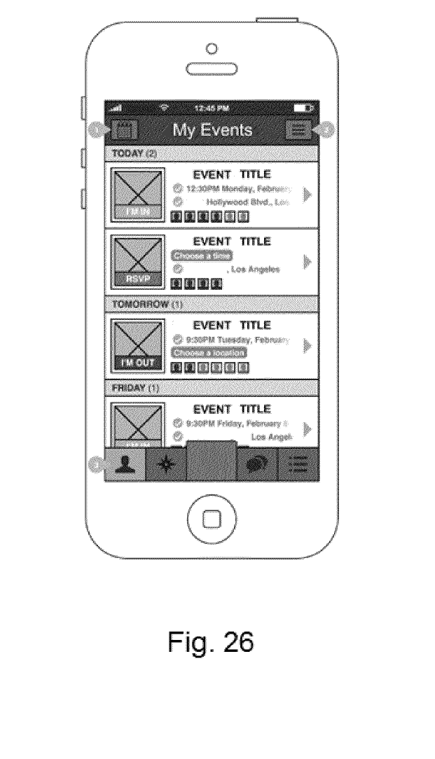

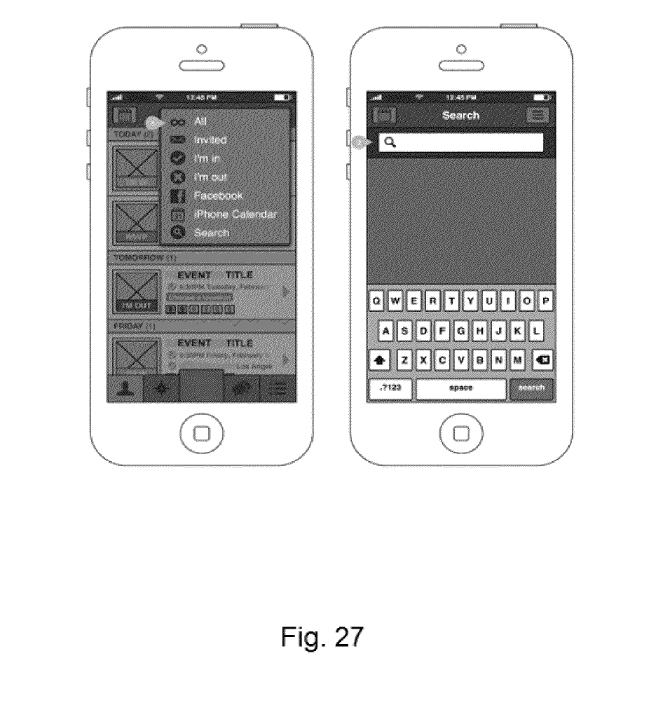

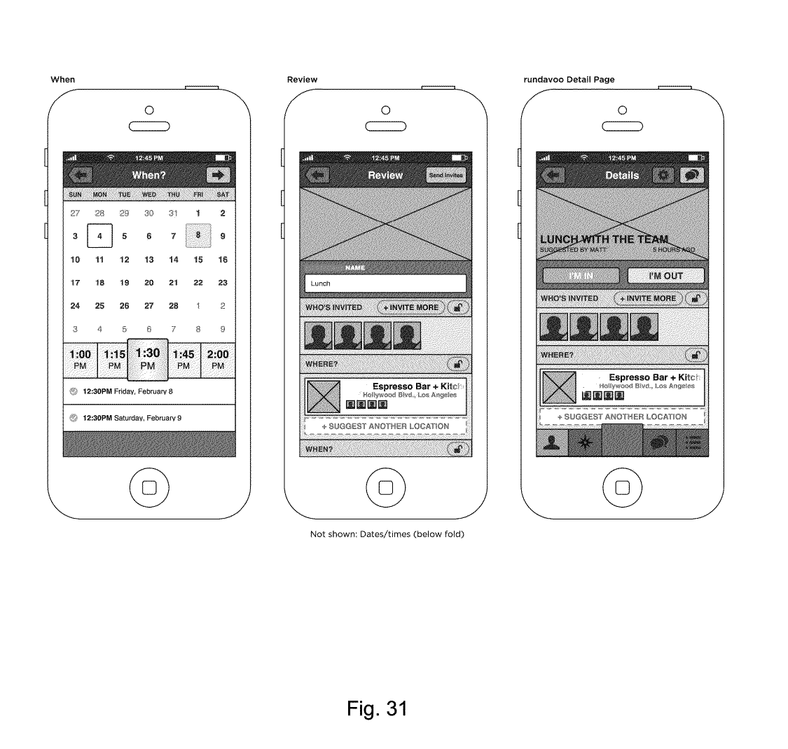

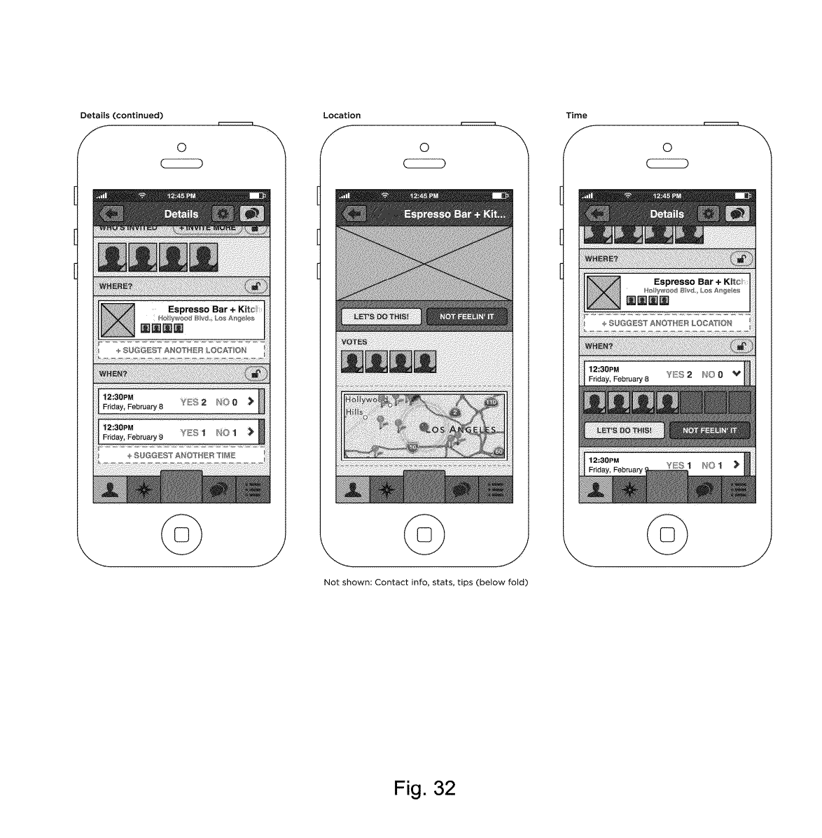

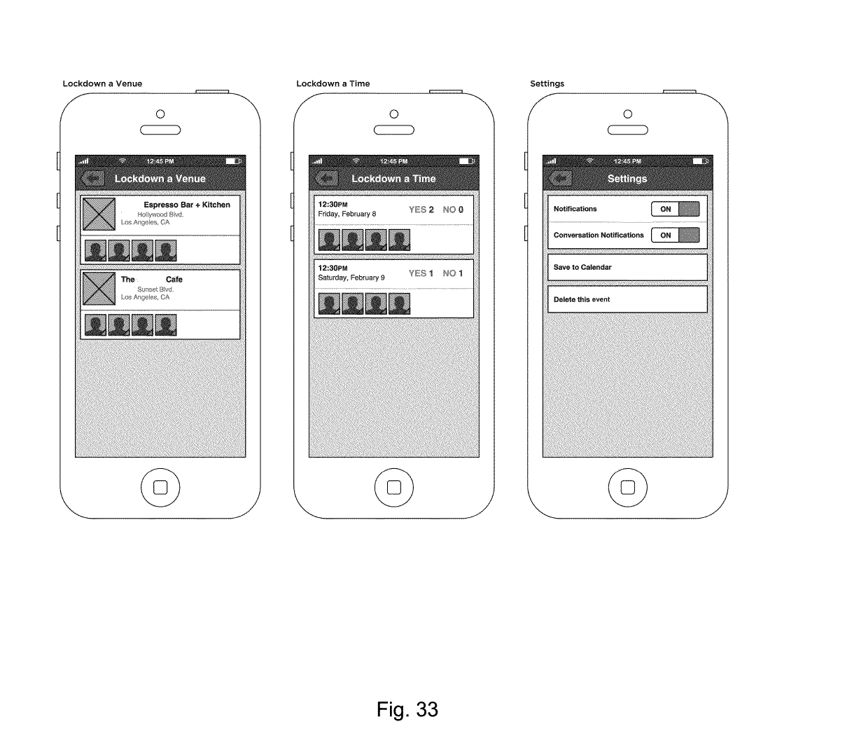

FIGS. 24-41 illustrate a mobile application for an iPhone for creating and using a Rundavoo planning tool. In general, as discussed above, the process includes initiating an event, inviting friends, suggesting and collaborating on details, such as time and place (i.e., determining what, who, when, and where). As shown in FIGS. 24 and 25, a separate screen can be used for each of the who, what, where and when determinations, in a linear or staggered process, with a review screen provided as well. As shown in FIG. 26, a toolbar can include a calendar button which opens a calendar view, and menu button that opens a filter menu pop-over. An application navigation bar appears at the bottom of the screen. In this example, options include My Rundavoos, locations, new Rundavoo launcher, group chats, and notifications/settings. FIG. 27 illustrates at 1 a filter menu appears when the user taps on the filter title. At 2, all options (other than Search) immediately filter the Rundavoos list. Tapping search on the filter menu displays the search bar and keyboard. Rundavoos that match search criteria appear below the search bar when the user taps “search” on the keyboard.

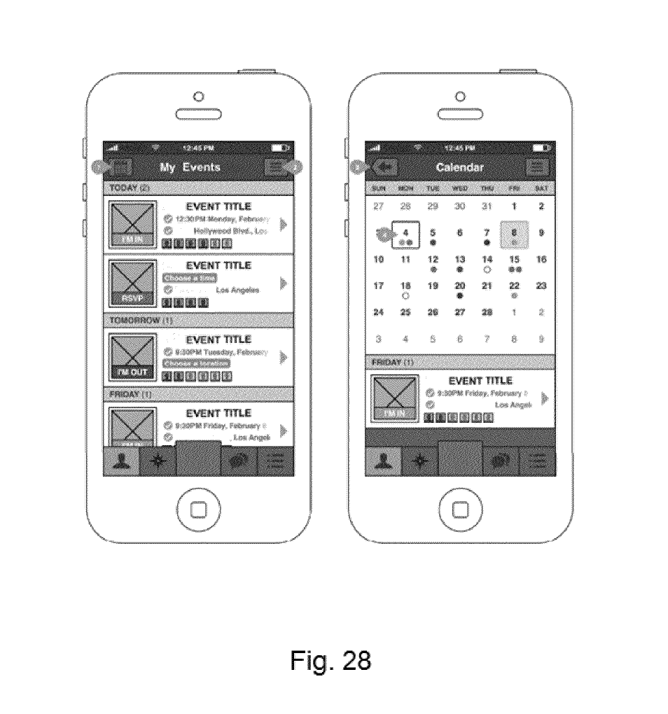

As shown in FIG. 28 at 1, a calendar button opens the calendar view. At 2, a menu button opens the filter menu pop-over. At 3, a back button returns to the “my rundavoos” view. At 4, days with Rundavoos appear with small dots under the date on the calendar. Different dot shadings or colors can indicate various things such as a) invited with no RSVP, b) I'm in, c) I'm out, d) Facebook event, e) iPhone calendar event.

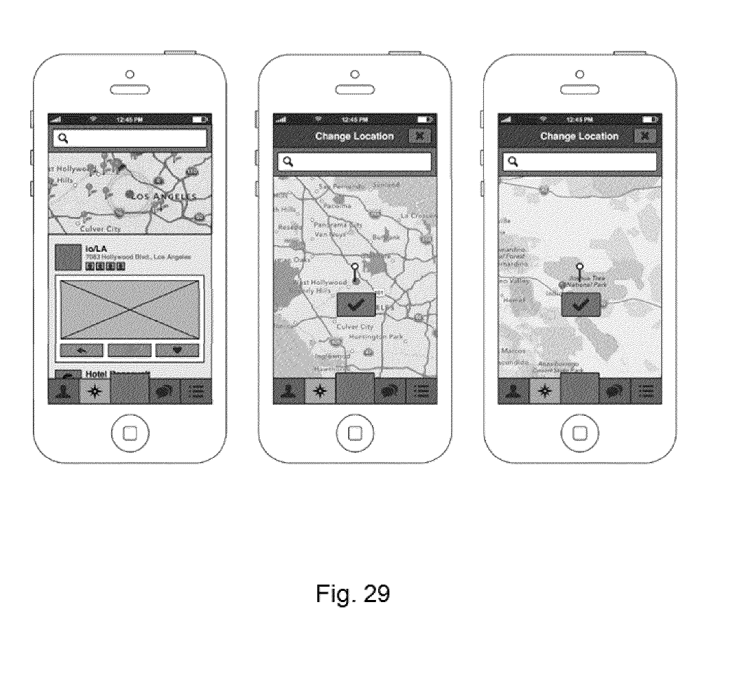

FIG. 29 illustrates a way to initiate a Rundavoo based on location. A user can select where he/she is and initiate the Rundavoo based on the selected location, such as via a map or location determination, such as by GPS. Once a Rundavoo is initiated based on a location (suggested location or firm location), other participants can be invited, and time and event can be determined. The location can be changed or other locations can be suggested.

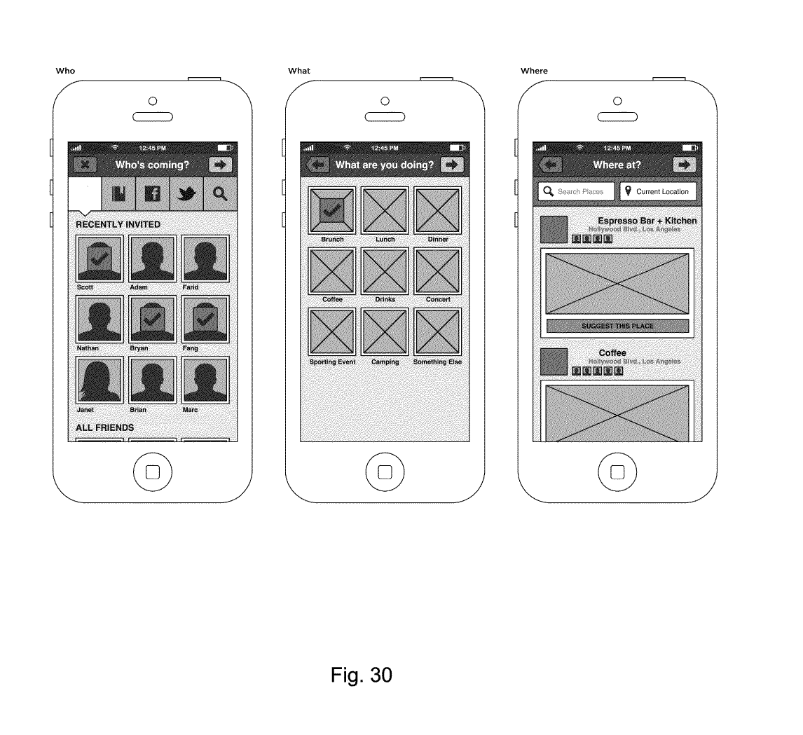

FIGS. 30-33 show various screens for determining the who, what, where, and when of an activity, screens for determining and locking down details of an activity, as well as Review and Event detail screens.

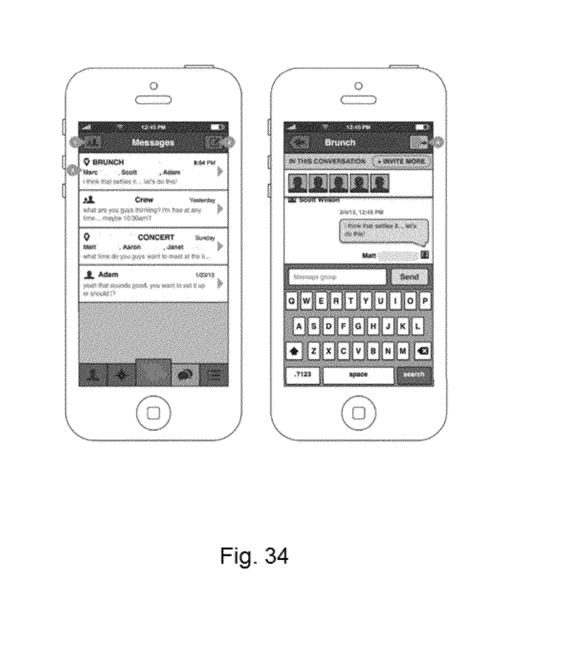

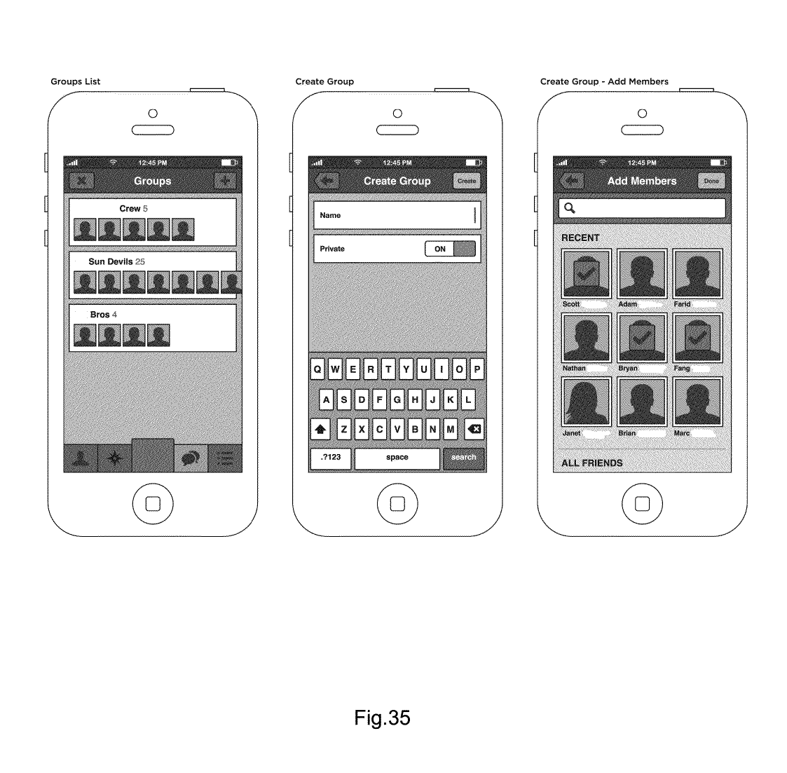

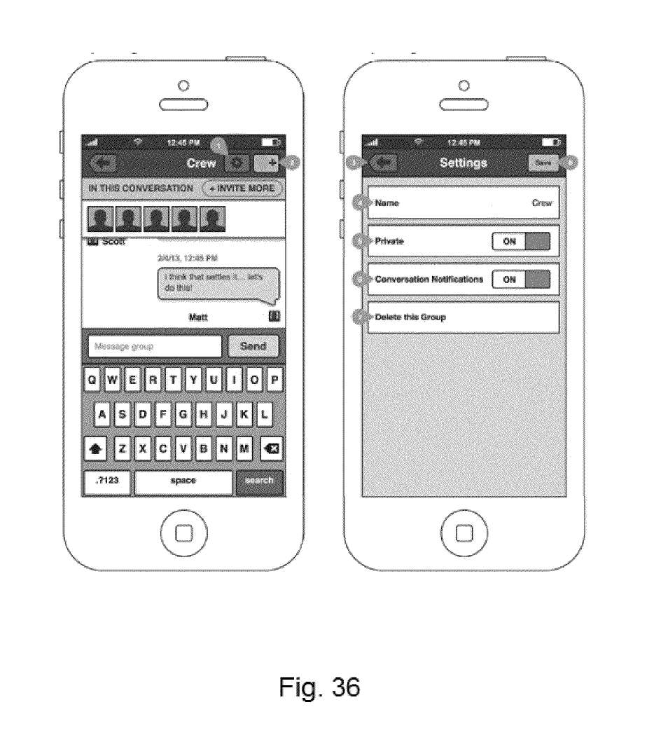

FIGS. 34-36 illustrate messaging features including the ability for Group Text. In particular, at 1 in FIG. 34 is a button to view and manage groups. At 2 is a button for composing new messages. At 3, messages can be categorized as one of three types: Rundavoo invitees, Group not tied to a specific Rundavoo, and user to user messages. At 4 is a button to view Rundavoos. FIG. 35 illustrates features/screens for creating and viewing groups. This allows for a Rundavoo to be initiated based on participants selected to receive group text(s). Various suggestions as to event attributes (where, when etc.) can be made. FIG. 36 illustrates various other features, including: at 1 a button for viewing group settings; at 2 a button to create a new Rundavoo with group members; at 3, a button to go back to previous view (e.g., group chat or group list); at 4, a name—visible to creator only—a tap allows the group name to be edited; at 5 a private toggle which is visible to only the group creator and allows for the ability to allow or disallow invitees to invite others; at 6, a conversations notifications toggle, which is visible to all group members, is on by default, and can be changed to disable notifications of new messages; at 7, a delete this group button is shown which can be visible to only the group creator—a tap allow opening confirmation dialog asking a user if they are sure they want to delete the group—if tapped then a group is deleted. A leave group button can also be included, which would be visible to all group members with the exception of the group creator. At 8, a Save button is show to allow changes to be made to group settings.

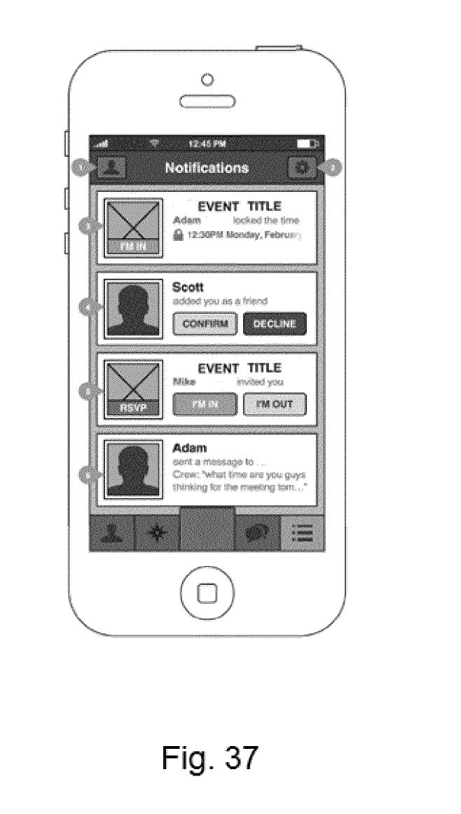

FIG. 37 illustrates Notifications. At 1, a profile button opens the user profile view. At 2, a setting button opens the application setting view. At 3 is a Rundavoo time/location locked notification. At 4 is a friend request notification, with the ability to confirm or decline request. At 5 is a Rundavoo invitation notification—select “I'm in” or “I'm out”. At 6 is a Rundavoo time/location locked notification.

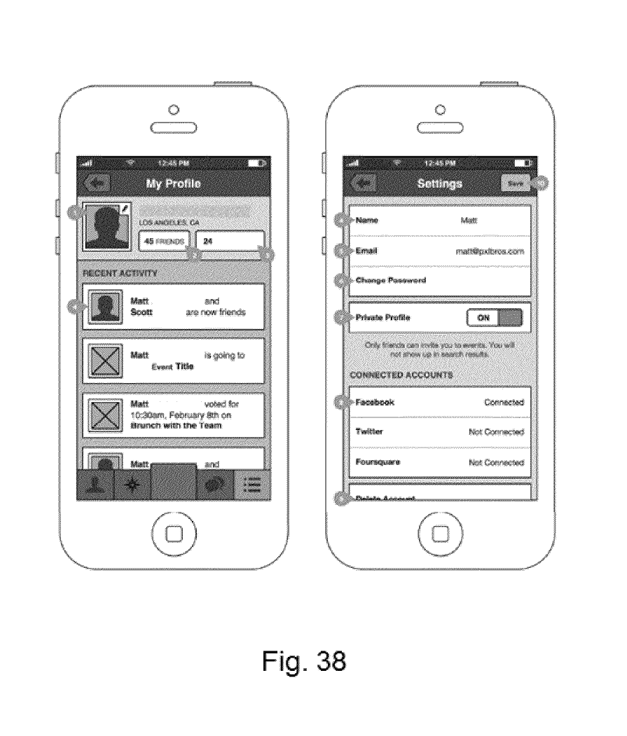

FIG. 38 illustrates User Profile and Account Settings screen.

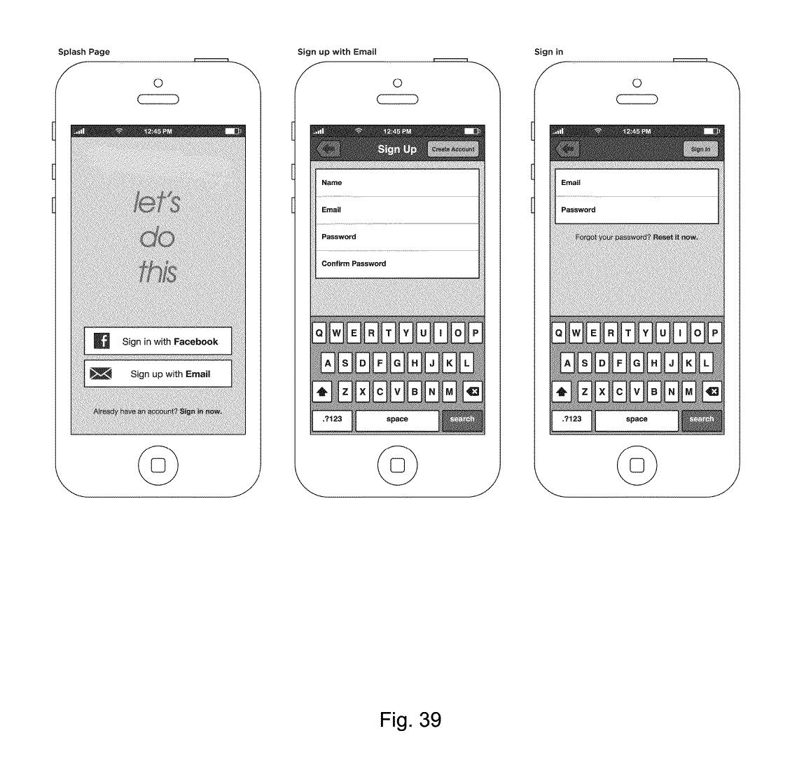

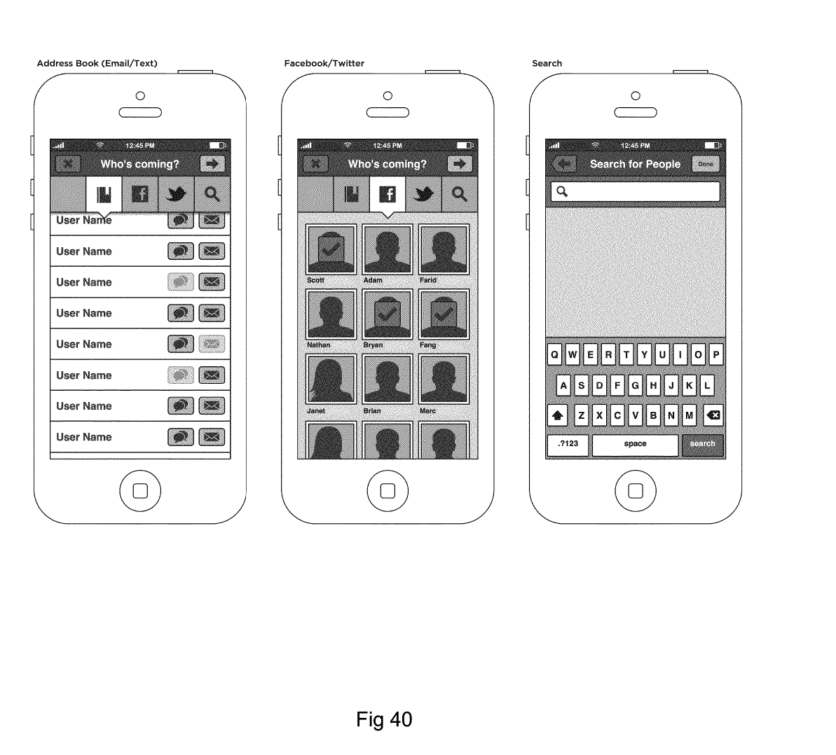

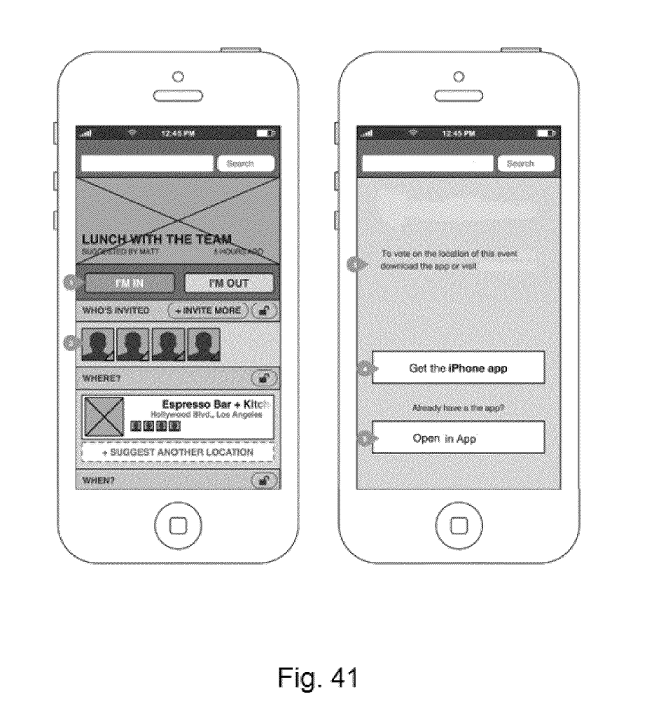

FIG. 39 illustrates a splash page, and sign in pages that allow for various login credentials such as described above. FIG. 40 illustrates Address book, Facebook/Twitter, and search screens. FIG. 41 illustrates a Mobile Rundavoo details page, and a download app mobile page. At 1 users who are sent a text or email link will be redirected to a Rundavoo page with a unique URL. Users can select “I'm In” or “I'm Out”, and their vote will be tallied on the Rundavoo pages. At 2, Users sent a text or email link can view who is invited and the proposed times and locations. At 3, if users try to vote on a time or location on the mobile site, they will be redirected to a download app mobile page. At 4, is a button to get the iPhone app, which navigates to the App Store. At 5 is a button to Open in Rundavoo, which launches the Rundavoo iPhone application.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein, may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed is:

1. A method comprising:
adding a gathering creation link to a publically accessible web page relating to an event, wherein interacting with the gathering creation link initiates the creation of a private plan web page;
receiving information via the gathering creation link to define a proposed gathering related to the event for a predefined group of potential participants; and
creating, with the received information, a private plan web page accessible to the defined group of potential participants, wherein the private plan web page provides information related to the proposed gathering and includes a transaction link for initiating a transaction related to the event.

2. The method of claim 1, wherein the initiated transaction is at least one of a purchase, a donation, and a reservation related to the event.

3. The method of claim 1, further comprising adding a transaction link to the publically accessible web page for initiating a transaction related to the event.

4. The method of claim 1, further comprising adding a second gathering creation link to a second publically accessible web page promoting the event, receiving second information via the second gathering creation link to define a second proposed gathering relating to the event for a second predefined group of potential participants; and creating, with the second received information, a second private plan web page accessible to the second predefined group of potential participants which includes a second transaction link for initiating a transaction related to the event.

5. The method of claim 1, further comprising soliciting and receiving from at least one participant in the group of potential participants at least one vote as to the value of at least one of a plurality of proposed gathering attributes; using the votes to select a value for at least one attribute of the proposed gathering; and wherein the transaction link relates to the selected value for one attribute of the proposed gathering.

6. The method of claim 5, wherein the private plan web page includes a plurality of transaction links relating to the plurality of proposed gathering attributes, wherein each transaction link interacts with at least one of a ticket purchasing service, a transportation booking service, a lodging booking service, a dining booking service, and an auxiliary event.

7. The method of claim 6, wherein each transaction link is at least one of directly integrated with the private plan web page and indirectly integrated with the private plan web page.

8. The method of claim 1, further comprising integrating the private plan web page with at least one of a travel planning tool, an itinerary organizer tool, an expense management and compliance tool, and a payment tool.

9. The method of claim 1, further comprising tracking statistics associated with created private plan web pages, wherein the tracked statistics include at least one of a number of private plan web pages, a number of participants invited, an average number of participants per private plan web page, a number of participants who viewed or joined a private plan web page, a number of purchasing transactions completed, and demographics of participants.

10. A method comprising:
embedding a gathering creation link on each of a plurality of publically accessible web pages related to an event, wherein each gathering creation link allows a user to define a proposed gathering related to the event;
receiving information via the gathering creation links to define respective proposed gatherings related to the event for respective predefined groups of potential participants; and
creating, with the received information, a respective private plan web page accessible to the respective defined group of potential participants for each of the proposed gatherings, wherein each private plan web page provides information related to the respective proposed gathering and includes a transaction link for initiating a transaction related to the event.

11. The method of claim 10, further comprising accessing a link/widget generator to control the distribution of gathering creating links on the plurality of publically accessible web pages.

12. The method of claim 11, further comprising adding a transaction link to each publically accessible web page to enable a purchasing transaction related to the event to be performed.

13. The method of claim 10, further comprising, for each proposed gathering, soliciting and receiving from at least one participant in the respective group of potential participants at least one vote as to the value of at least one of a plurality of proposed gathering attributes for the respective proposed gathering; and using the votes to select a value for at least one attribute of the respective proposed gathering.

14. The method of claim 13, wherein each private plan web page includes a plurality of transaction links relating to the plurality of proposed gathering attributes, wherein each transaction link interacts with at least one of a ticket purchasing service, a transportation booking service, a lodging booking service, a dining booking service, and an auxiliary event.

15. The method of claim 14, wherein each transaction link is at least one of directly integrated with the private plan web page and indirectly integrated with the private plan web page.

16. The method of claim 10, further comprising integrating a private plan web page with at least one of a travel planning tool, an itinerary organizer tool, an expense management and compliance tool, and a payment tool.

17. The method of claim 10, further comprising tracking statistics associated with created private plan web pages, wherein the tracked statistics include at least one of a number of private plan web pages associated with an event, a number of participants invited, an average number of participants per private plan web page, a number of participants who viewed or joined a private plan web page, a number of purchasing transactions completed, and demographics of participants.
